(19) United States
(12) Patent Application Publication
(10) Pub. No.: US 2011/0112853 A1
(43) Pub. Date: May 12, 2011

(54) System and Method for Condition, Cost, and Duration Analysis

(75) Inventors: T. C. Tong, Bloomington, MN (US); Jean W. Rawlings, Roy, UT (US); David R. Anderson, Chaska, MN (US); Christopher A. Hane, Irvine, CA (US); Sean St. Clair, Fort Washington, PA (US); Carol Butler, Bluffdale, UT (US)

(73) Assignee: INGENIX, INC., Eden Prairie, MN (US)

(21) Appl. No.: 12/939,583

(22) Filed: Nov. 4, 2010

Related U.S. Application Data
(60) Provisional application No. 61/258,969, filed on Nov. 6, 2009.

(51) Int. Cl. G06Q 50/00; G06Q 10/00

(52) U.S. Cl. 705/2

(57) ABSTRACT

A system, method, and tangible computer program product for analysis of condition, cost, and duration are presented. In one embodiment, the system includes an interface and a processor. The interface may receive or obtain one or more attributes associated with a subject having a condition. The processor may search a database for a group of records associated with the attributes, wherein the records comprise cost and duration information associated with the condition, estimate cost and duration in response to the cost and duration information, and generate an output in response to the cost estimate and duration estimate.

### CROSS-REFERENCE TO RELATED APPLICATIONS

This application claims priority to U.S. Provisional Application No. 61/258,969 filed Nov. 6, 2009, the entire contents of which is specifically incorporated herein by reference without disclaimer.

This application is related to U.S. application Ser. No. 12/605,697 filed on Oct. 26, 2009 and U.S. application Ser. No. 12/562,608 filed on Sep. 18, 2009, the entire disclosures of which are specifically incorporated herein by reference in their entirety without disclaimer.

### BACKGROUND OF THE INVENTION

1. Field of the Invention

This invention relates to health related data analysis and more particularly relates to a system and method for an integrated analysis of condition, cost, and duration.

2. Description of the Related Art

Most corporations, including health insurance corporations, maintain a high volume of data. Such data may be analyzed and exploited for valuable information regarding business trends, and other important statistics. Data mining is a common strategy for identifying and analyzing such data.

There are many various forms of data mining. Custom analytic operations may be developed to meet specific needs. Alternatively, commercially available statistical analysis tools such as Statistical Analysis Software (SAS) may be used to identify statistical trends in data.

Health insurance companies typically maintain databases of health insurance claim information, demographic information, and other data about health insurance plan members. Such information may be used to gain valuable insights into disease causes, progressions, and potential cures. Unfortunately, typical methods for analyzing such data are often cumbersome, costly, and require unworkably high processing times and resources.

For example, currently the process to determine cost and duration for a specific condition such as a disability, is a manual process performed by multiple vendors and is based on information gathered from a few physician offices for a couple of patients with similar disabilities. This process takes at least six weeks but can take up to three months, and costs disability carriers approximately $6K per member per year. One disability carrier, like Travelers, spends ˜$40M per year to determine cost and durations for specific individuals with a long-term disability.

The referenced shortcomings are not intended to be exhaustive, but rather are among many that tend to impair the effectiveness of previously known techniques disease management; however, those mentioned here are sufficient to demonstrate that the methodologies appearing in the art have not been satisfactory and that a significant need exists for the techniques described and claimed in this disclosure.

### SUMMARY OF THE INVENTION

From the foregoing discussion, it should be apparent that a need exists for a program product, system, and method for analysis of condition, cost, and duration.

A system is presented for analysis of condition, cost, and duration. In one embodiment, the system includes a data storage device configured to store a database comprising one or more records, each record having one or more attributes. The system may also include a server in data communication with the data storage device. The server may obtain one or more attributes associated with a subject having a condition, search a database stored on a data storage device for a group of records associated with the attributes, wherein the records comprise cost and duration information associated with the condition, estimate cost and duration in response to the cost and duration information, and generate an output in response to the cost estimate and duration estimate.

In certain embodiments, the condition of the present invention may be a specific condition, or a combination of multiple specific conditions. Non-limiting examples of a specific condition include a short term disability, a long term disability, and a permanent disability.

In one embodiment, the server may filter the records according to a limiting criterion. In a further embodiment, the server may extract the cost and duration information of a predetermined time period. The server may also aggregate records based on the cost and duration information. In still another embodiment, the server may calculate a benchmark for cost and duration of the condition or its associated service. In a still further embodiment, the server may determine ranges and trends for cost and duration of the condition or its associated service.

A method is also presented for analysis of condition, cost, and duration. The method in the disclosed embodiments substantially includes the steps necessary to carry out the functions presented above with respect to the operation of the described system. In one embodiment, the method includes obtaining one or more attributes associated with a subject having a condition, searching a database stored on a data storage device for a group of records associated with the attributes, wherein the records comprise cost and duration information associated with the condition, estimating cost and duration in response to the cost and duration information, and generating an output in response to the cost estimate and duration estimate.

In a further embodiment, the method may include filtering the records according to a limiting criterion. The method may also include extracting cost and duration information of a predetermined time period. Additionally, the method may include aggregating the records based on the cost and duration information.

In a still further embodiment, the method may include calculating a benchmark for cost and duration of the condition or its associated service. In a certain embodiment, the method may also include determining ranges and trends for cost and duration of the condition or its associated service.

A tangible computer program product comprising a computer readable medium having computer usable program code executable to perform operations is also presented. In one embodiment, the operations may comprise obtaining one or more attributes associated with a subject having a condition, searching a database stored on a data storage device for a group of records associated with the attributes, wherein the records comprise cost and duration information associated with the condition, estimating cost and duration in response to the cost and duration information, and generating an output in response to the cost estimate and duration estimate.

In a certain embodiment, the operations may include filtering the records according to a limiting criterion. The operations may also include extracting cost and duration information of a predetermined time period. Additionally, the operations may include aggregating the records based on the cost and duration information. In a further embodiment, the operations may include calculating a benchmark for cost and duration of the condition or its associated service. In addition, the operations may include determining ranges and trends for cost and duration of the condition or its associated service.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages could become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram illustrating one embodiment of a system for analysis of condition, cost, and duration;

FIG. 2 is a schematic block diagram illustrating one embodiment of a database system for analysis of condition, cost, and duration;

FIG. 3 is a schematic block diagram illustrating one embodiment of a computer system that may be used in accordance with certain embodiments of the system for analysis of condition, cost, and duration;

FIG. 4 is a schematic logical diagram illustrating the various layers of operation in a system for analysis of condition, cost, and duration;

FIG. 5 is a schematic block diagram illustrating one embodiment of a system for analysis of condition, cost, and duration;

FIG. 6 is a schematic block diagram illustrating another embodiment of a system for analysis of condition, cost, and duration;

FIG. 7 is a schematic flowchart diagram illustrating one embodiment of a method for analysis of condition, cost, and duration;

FIG. 8 is a schematic flowchart diagram illustrating another embodiment of a method for analysis of condition, cost, and duration;

FIG. 9 is a schematic block diagram illustrating one embodiment of a method for analysis of condition, cost, and duration.

FIG. 10 is a graphical representation illustrating one embodiment of an output from analysis of condition, cost, and duration;

FIG. 11 is a table illustrating one embodiment of an output from analysis of condition, cost, and duration;

FIG. 12 is a graphical representation illustrating one embodiment of an output from analysis of condition, cost, and duration;

FIG. 13 is a graphical representation illustrating one embodiment of an output from analysis of condition, cost, and duration;

FIG. 14 is a graphical representation illustrating one embodiment of an output from analysis of condition, cost, and duration;

FIG. 15 is a screen-shot diagram illustrating one embodiment of a graphical user interface for analysis of condition, cost, and duration.

FIG. 16 is a screen-shot diagram illustrating one embodiment of an estimate calculated by analysis of condition, cost, and duration.

FIG. 17 is a graphical representation illustrating one embodiment of an output from analysis of condition, cost, and duration;

FIG. 18 is a table illustrating one embodiment of an output from analysis of condition, cost, and duration;

FIG. 19 is a graphical representation illustrating one embodiment of an output from analysis of condition, cost, and duration;

FIG. 20 is a graphical representation illustrating one embodiment of an output from analysis of condition, cost, and duration;

FIG. 21 is a graphical representation illustrating one embodiment of an output from analysis of condition, cost, and duration;

FIG. 22 is a screen-shot diagram illustrating one embodiment of a graphical user interface for analysis of condition, cost, and duration.

FIG. 23 is a screen-shot diagram illustrating one embodiment of a graphical user interface for analysis of condition, cost, and duration.

FIG. 24 is a screen-shot diagram illustrating one embodiment of a graphical user interface for analysis of condition, cost, and duration.

FIG. 25 is a screen-shot diagram illustrating one embodiment of a graphical user interface for analysis of condition, cost, and duration.

FIG. 26 is a screen-shot diagram illustrating one embodiment of a graphical user interface for analysis of condition, cost, and duration.

FIG. 27 is a screen-shot diagram illustrating one embodiment of a graphical user interface for analysis of condition, cost, and duration.

FIG. 28 is a screen-shot diagram illustrating one embodiment of a graphical user interface for analysis of condition, cost, and duration.

FIG. 29 is a screen-shot diagram illustrating one embodiment of a graphical user interface for analysis of condition, cost, and duration.

FIG. 30 is a screen-shot diagram illustrating one embodiment of a graphical user interface for analysis of condition, cost, and duration.

FIG. 31 is a screen-shot diagram illustrating one embodiment of a graphical user interface for analysis of condition, cost, and duration.

FIG. 32 is a screen-shot diagram illustrating one embodiment of a graphical user interface for analysis of condition, cost, and duration.

FIG. 33 is a screen-shot diagram illustrating one embodiment of a graphical user interface for analysis of condition, cost, and duration.

FIG. 34 is a screen-shot diagram illustrating one embodiment of a graphical user interface for analysis of condition, cost, and duration.

### DETAILED DESCRIPTION

Various features and advantageous details are explained more fully with reference to the non-limiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept could become apparent to those skilled in the art from this disclosure.

Certain units described in this specification have been labeled as modules, in order to more particularly emphasize their implementation independence. A module is “[a] self-contained hardware or software component that interacts with a larger system.” Alan Freedman, “The Computer Glossary” 268 (8th ed. 1998). A module comprises a component of a machine, a machine or a plurality of machines that are suitably programmed to operate according to executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, a controller, or the like.

Modules may also include software-defined units or instructions that, when executed by a processing machine or device, retrieve and transform data stored on a data storage device from a first state to a second state. An identified module of executable code may, for instance, comprise one or more physical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated data transformation.

Indeed, a module of executable code maybe a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art could recognize, however, that the invention may be practiced without one or more of the specific details, or with other methods, components, materials, and so forth. In other instances, well-known structures, materials, or operations are not shown or described in detail to avoid obscuring aspects of the invention.

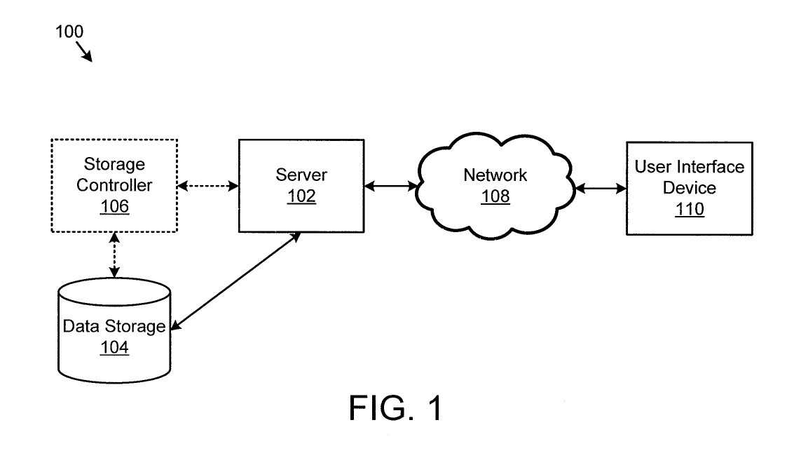

FIG. 1 illustrates one embodiment of a system 100 for analysis of condition, cost, and duration. The system 100 may include a server 102 and a data storage device 104. In a further embodiment, the system 100 may include a network 108 and a user interface device 110. In still another embodiment, the system 100 may include a storage controller 106 or storage server configured to manage data communications between the data storage device 104 and the server 102 or other components in communication with the network 108. In an alternative embodiment, the storage controller 106 may be coupled to the network 108. In a general embodiment, the system 100 may store databases comprising records, perform searches of those records, and calculate statistics in response to information contained in those records.

Specifically, the system 100 may aggregate records based on the cost and duration information. In still another embodiment, the server 102 may generate an output in response to the cost and duration information. For example, the server 102 may calculate a benchmark or determine ranges and trends for cost and duration of the condition or its associated service.

In one embodiment, the user interface device 110 is referred to broadly and is intended to encompass a suitable processor-based device such as a desktop computer, a laptop computer, a Personal Digital Assistant (PDA), a mobile communication device or organizer device having access to the network 108. In a further embodiment, the user interface device 110 may access the Internet to access a web application or web service hosted by the server 102 and provide a user interface for enabling the service consumer (user) to enter or receive information. For example, the user may enter one or more attributes, such as a predetermined time period, limiting criteria, a selected attribute for aggregating or reporting a statistic, or the like.

The network 108 may facilitate communications of data between the server 102 and the user interface device 110. The network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another.

In one embodiment, the server 102 may receive an attribute, search the database for a group of records associated with the attribute, wherein the records comprise cost and duration information associated with the condition, estimate cost and duration in response to the cost and duration information, and generate an output in response to the cost and duration estimate. Additionally, the server 102 may access data stored in the data storage device 104 via a Storage Area Network (SAN) connection, a LAN, a data bus, or the like.

The data storage device 104 may include a hard disk, including hard disks arranged in an Redundant Array of Independent Disks (RAID) array, a tape storage drive comprising a magnetic tape data storage device, an optical storage device, or the like. In one embodiment, the data storage device 104 may store health related data, such as insurance claims data, consumer data, or the like. The data may be arranged in a database and accessible through Structured Query Language (SQL) queries, or other data base query languages or operations.

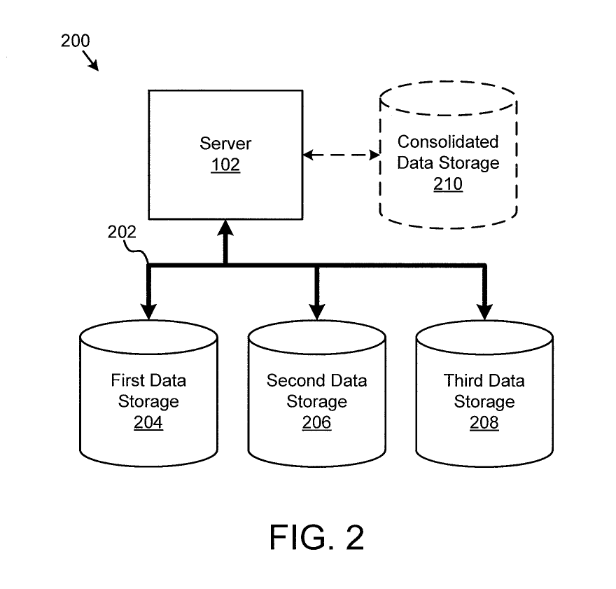

FIG. 2 illustrates one embodiment of a data management system 200 configured to store and manage data for analysis of condition, cost, and duration. In one embodiment, the system 200 may include a server 102. The server 102 may be coupled to a data-bus 202. In one embodiment, the system 200 may also include a first data storage device 204, a second data storage device 206 and/or a third data storage device 208. In further embodiments, the system 200 may include additional data storage devices (not shown). In such an embodiment, each data storage device 204-208 may host a separate database of cost and duration data, healthcare claims data, lab data, physical test data, disease progression data, demographic data, socioeconomic data, or the like. The customer information in each database may be keyed to a common field or identifier, such as an individual's name, social security number, customer number, or the like. Alternatively, the storage devices 204-208 may be arranged in a RAID configuration for storing redundant copies of the database or databases through either synchronous or asynchronous redundancy updates.

In one embodiment, the server 102 may submit a query to selected data storage devices 204-208 to collect a consolidated set of data elements associated with an individual or a group of individuals. The server 102 may store the consolidated data set in a consolidated data storage device 210. In such an embodiment, the server 102 may refer back to the consolidated data storage device 210 to obtain a set of data elements associated with a specified individual. Alternatively, the server 102 may query each of the data storage devices 204-208 independently or in a distributed query to obtain the set of data elements associated with a specified individual. In another alternative embodiment, multiple databases may be stored on a single consolidated data storage device 210.

In various embodiments, the server 102 may communicate with the data storage devices 204-210 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), and/or other similar data communication schemes associated with data storage and communication. For example, the server 102 may communicate indirectly with the data storage devices 204-210, the server first communicating with a storage server or storage controller 106.

In one example of the system 200, the first data storage device 204 may store data associated with insurance claims made by one or more individuals. The insurance claims data may include cost and duration data associated with medical services, procedures, and prescriptions utilized by the individual. In one particular embodiment, the first data storage device 202 may include insurance claims data for over 56 million customers of a health insurance company. The database may include claims data spanning over 14 years. Of those 56 million members, 26 million had a five year history or more. In one embodiment, the second data storage device 206 may store summary data associated with the individual. The summary data may include one or more diagnoses of conditions from which the individual suffers and/or actuarial data associated with an estimated cost in medical services that the individual is likely to incur. The third data storage device 208 may store lab test data associated with the individual. For example, the third data storage device 208 may include data associated with the individual's lab test results and/or clinical observations. A fourth data storage device (not shown) may store demographic data. For example, the demographic data may include information relating to the individual's demographics include gender, race or ethnicity, age, income, disabilities, mobility, educational attainment, home ownership, employment status, location, or the like.

The server 102 may host a software application configured for analysis of condition, cost, and duration. The software application may further include modules or functions for interfacing with the data storage devices 204-210, interfacing with a network 108, interfacing with a user, and the like. In a further embodiment, the server 102 may host an engine, application plug-in, or application programming interface (API). In another embodiment, the server 102 may host a web service or web accessible software application.

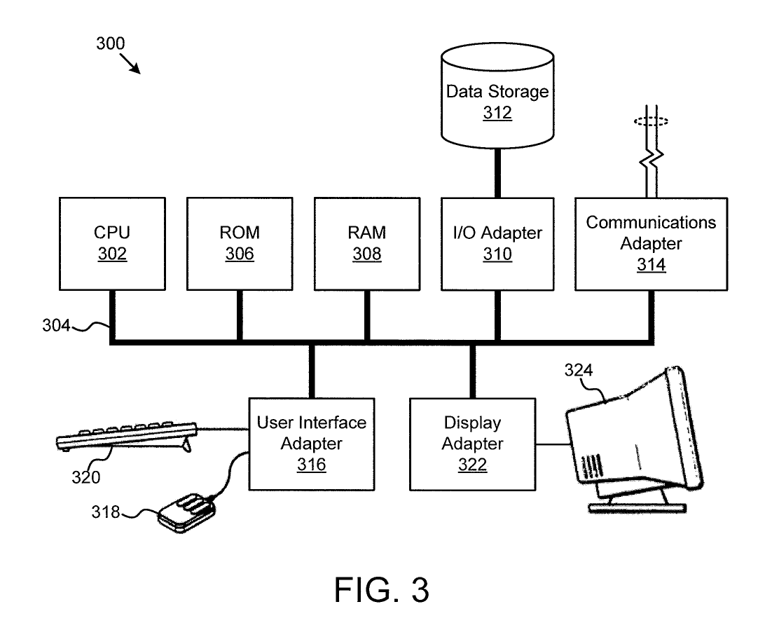

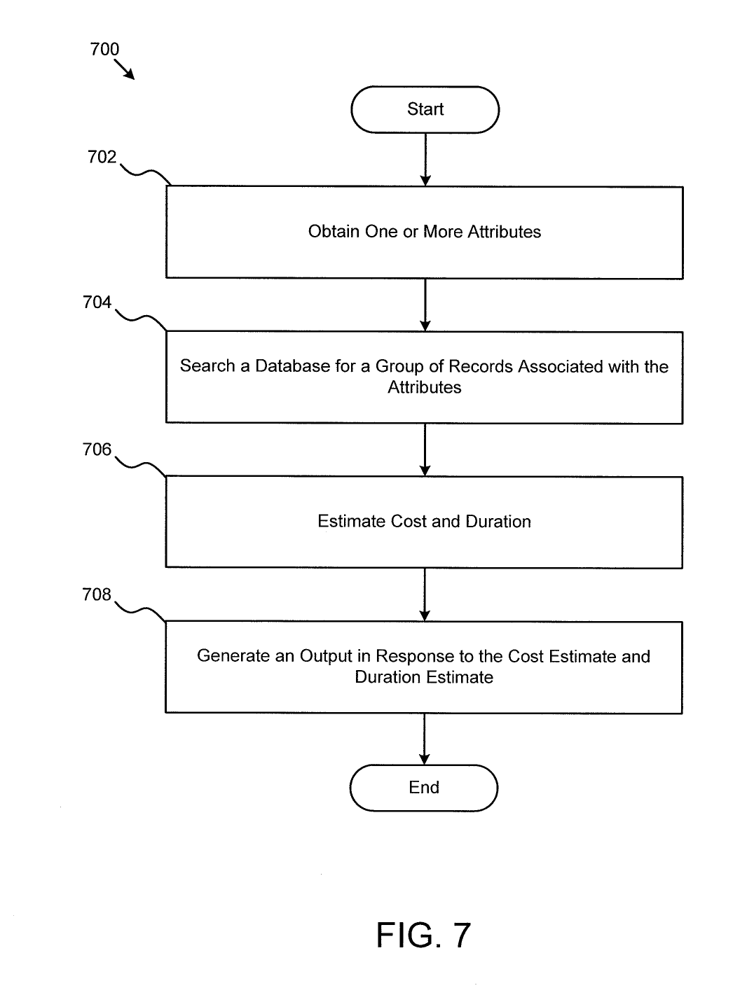

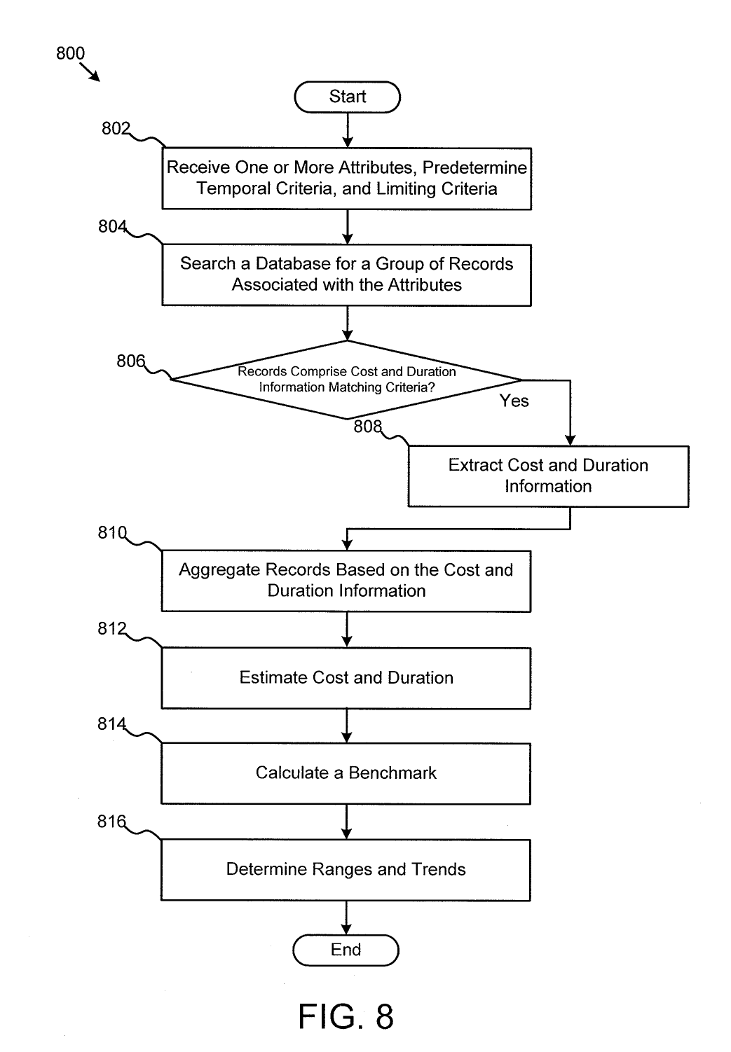

FIG. 3 illustrates a computer system 300 adapted according to certain embodiments of the server 102 and/or the user interface device 110. The central processing unit (CPU) 302 is coupled to the system bus 304. The CPU 302 may be a general purpose CPU or microprocessor. The present embodiments are not restricted by the architecture of the CPU 302, so long as the CPU 302 supports the modules and operations as described herein. The CPU 302 may execute the various logical instructions according to the present embodiments. For example, the CPU 302 may execute machine-level instructions according to the exemplary operations described below with reference to FIGS. 7-8.

The computer system 300 also may include Random Access Memory (RAM) 308, which may be SRAM, DRAM, SDRAM, or the like. The computer system 300 may utilize RAM 308 to store the various data structures used by a software application configured for analysis of condition, cost, and duration. The computer system 300 may also include Read Only Memory (ROM) 306 which may be PROM, EPROM, EEPROM, or the like. The ROM may store configuration information for booting the computer system 300. The RAM 308 and the ROM 306 may hold user and system 100 data.

The computer system 300 may also include an input/output (I/O) adapter 310, a communications adapter 314, a user interface adapter 316, and a display adapter 322. The I/O adapter 310 and/or user the interface adapter 316 may, in certain embodiments, enable a user to interact with the computer system 300 in order to input information for authenticating a user, identifying an individual, or receiving health profile information. In a further embodiment, the display adapter 322 may display a graphical user interface associated with a software or web-based application for analysis of condition, cost, and duration.

The I/O adapter 310 may connect one or more storage devices 312, such as one or more of a hard drive, a Compact Disk (CD) drive, a floppy disk drive, a tape drive, to the computer system 300. The communications adapter 314 may be adapted to couple the computer system 300 to the network 108, which may be one or more of a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of system 300. Rather the computer system 300 is provided as an example of one type of computing device that may be adapted to perform the functions of server 102 and/or the user interface device 110. For example, any suitable processor-based device may be utilized including without limitation, including personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

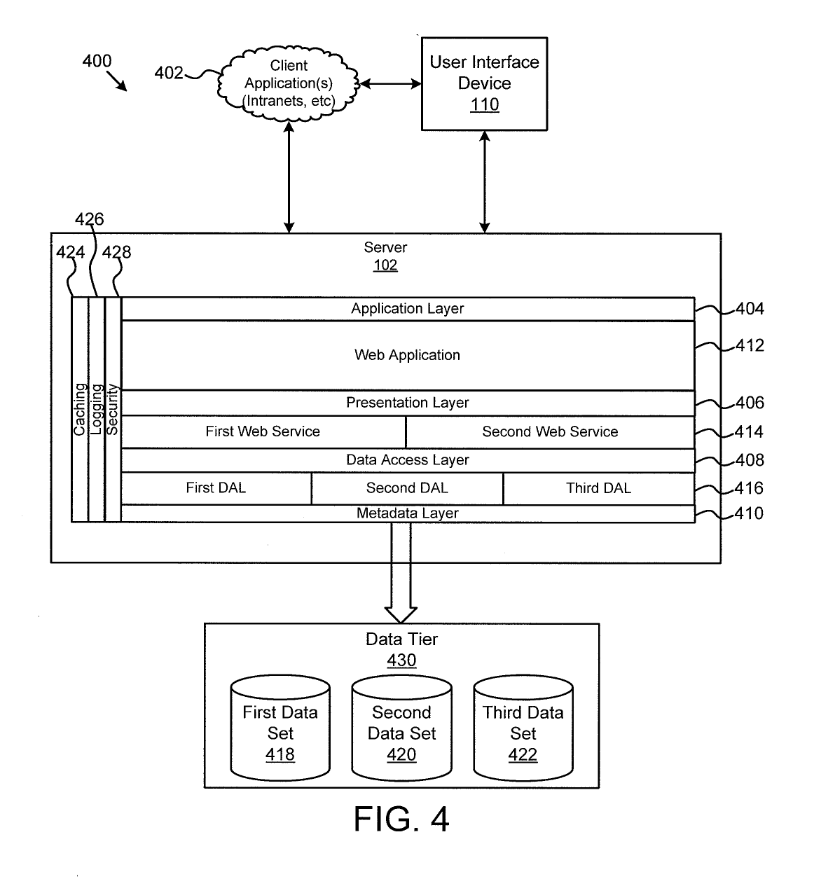

FIG. 4 illustrates one embodiment of a network-based system 400 for analysis of condition, cost, and duration. In one embodiment, the network-based system 400 includes a server 102. Additionally, the network-based system 400 may include a user interface device 110. In still a further embodiment, the network-based system 400 may include one or more network-based client applications 402 configured to be operated over a network 108 including an intranet, the Internet, or the like. In still another embodiment, the network-based system 400 may include one or more data storage devices 104.

The network-based system 400 may include components or devices configured to operate in various network layers. For example, the server 102 may include modules configured to work within an application layer 404, a presentation layer 406, a data access layer 408 and a metadata layer 410. In a further embodiment, the server 102 may access one or more data sets 418-422 that comprises a data layer or data tier 430. For example, a first data set 418, a second data set 420 and a third data set 422 may comprise data tier 430 that is stored on one or more data storage devices 204-208.

One or more web applications 412 may operate in the application layer 404. For example, a user may interact with the web application 412 though one or more I/O interfaces 318 and 320 configured to interface with the web application 412 through an I/O adapter 310 that operates on the application layer. In one particular embodiment, a web application 412 may be provided for analysis of condition, cost, and duration that includes software modules configured to perform the steps of obtaining one or more attributes associated with a subject having a condition, searching a database stored on a data storage device for a group of records associated with the attributes, wherein the records comprise cost and duration information associated with the condition, estimating cost and duration in response to the cost and duration information, and generating an output in response to the cost estimate and duration estimate.

In a further embodiment, the server 102 may include components, devices, hardware modules, or software modules configured to operate in the presentation layer 406 to support one or more web services 414. For example, a web application 412 may access a web service 414 to perform one or more web-based functions for the web application 412. In one embodiment, a web application 412 may operate on a first server 102 and access one or more web services 414 hosted on a second server (not shown) during operation.

For example, a web application 412 for identifying cohorts and/or analyzing cohort cost and duration data, or other information may access a first web service 414 for identifying a first group of individuals associated with one or more attributes associated with an individual, and a second web service 414 for extracting cost and duration information from the records. The web services 414 may receive one or more attributes or generate a profile of the individual. In response, the web service 414 may return a list of records associated with the attributes or profile, statistics, graphs, or the like. One of ordinary skill in the art could recognize various web-based architectures employing web services 414 for modular operation of the web application 412.

In one embodiment, a web application 412 or a web service 414 may access one or more of the data sets 418-422 through the data access layer 408. In certain embodiments, the data access layer 408 may be divided into one or more independent data access layers (DAL) 416 for accessing individual data sets 418-422 in the data tier 430. These individual data access layers 416 may be referred to as data sockets or adapters. The data access layers 416 may utilize metadata from the metadata layer 410 to provide the web application 412 or the web service 414 with specific access to the data sets 418-422.

For example, the data access layer 416 may include operations for performing a query of the data sets 418-422 to retrieve specific information for the web application 412 or the web service 414. In a more specific example, the data access layer 416 may include a query for records associated with individuals who have been diagnosed with degeneration of intervertebral disc or that are associated with an ICD-9 code (e.g., ICD-9-M 722.4) associated with a diagnosis of degeneration of intervertebral disc and also match some additional predetermined attributes, such as age, gender, or residence location.

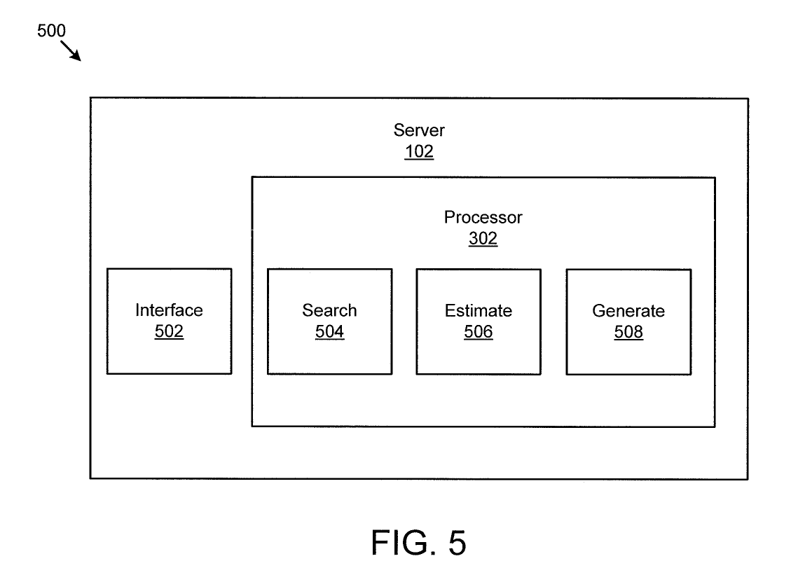

FIG. 5 illustrates one embodiment of a system 500 for analysis of condition, cost, and duration. In one embodiment, the system 500 is a server 102 configured to load and operate software modules 502-508 configured for analysis of condition, cost, and duration. Alternatively, the system 500 may include hardware modules 502-508 configured with analogue or digital logic, firmware executing FPGAs, or the like configured to perform the steps of obtaining one or more attributes associated with a subject having a condition, searching a database stored on a data storage device for a group of records associated with the attributes, wherein the records comprise cost and duration information associated with the condition, estimating cost and duration in response to the cost and duration information, and generating an output in response to the cost estimate and duration estimate. In such embodiments, the system 500 may include a CPU 302 and an interface 502, such as an I/O adapter 310, a communications adapter 314, a user interface adapter 316, or the like.

In one embodiment, the CPU 302 may include one or more software defined modules configured to obtain one or more attributes associated with a subject having a condition, search a database stored on a data storage device for a group of records associated with the attributes, wherein the records comprise cost and duration information associated with the condition, estimate cost and duration in response to the cost and duration information, and generate an output in response to the cost estimate and duration estimate. In one embodiment, these modules may include a search module 504, an estimate module 506, and a generate module 508.

In certain embodiments, the attribute may include a diagnosis code associated with a condition. The condition may be a specific condition or a combination of multiple conditions. For example, the condition may be a short term disability, a long term disability, a permanent disability, a disease, a co-morbidity condition, a health-related condition, a retirement, or a combination thereof. Such a disease may include any disease known to persons of ordinary skill in the art, such as a neoplasm.

The attribute may, in certain circumstances, include a plurality of attributes. This may be referred to as a “profile.” In certain embodiments, it may be helpful for a user of the present program product, system, and method to identify occurrences of a particular combination of conditions, diagnoses, events, characteristics, or the like. For example, the attributes contain a diagnosis of the condition and one or more demographic or geographic features. In such an example, an insurance company may desire to know the information and estimates of males in the age of 44 who have malignant neoplasm of colon (ICD-9-CM Diagnosis Code 153) and live in the New York state. Thus, the attributes in this example may include the diagnosis code, an age attribute having a value of ‘44;’ a gender attribute having a value of ‘male,’ a demographic residence of ‘New York state’ The attributes may also comprise a profile including a range of values or a broader category corresponding to certain attributes of an individual, for example, a profile of a person being within the age range of 40-49, male, having malignant neoplasm of large intestine, and residing in the Northeastern area of the United States. Other examples of attributes may include age, gender, area, minority status, income level, etc.

In a further embodiment, the attributes may include a temporal component. For example, the attribute may include a time period associated with the condition a long term disability such as, for example, malignant neoplasm of large intestine. In such an embodiment, the attribute would include the disability condition and a related time frame, such as a median life expectancy of the cancer. In such an example, the group of records may include all large intestine cancer patients with cost and duration information within the specified time frame of cancer onset or initial diagnosis (which could be either an ICD9 code or a lab reading or both).

Although the various functions of the server 102 and the CPU 302 are described in the context of modules, the methods, processes, and software described herein are not limited to a modular structure. Rather, some or all of the functions described in relation to the modules of FIGS. 7-8 may be implemented in various formats including, but not limited to, a single set of integrated instructions, commands, code, queries, etc. In one embodiment, the functions may be implemented in database query instructions, including SQL, PLSQL, or the like. Alternatively, the functions may be implemented in software coded in C, C++, C#, php, Java, or the like. In still another embodiment, the functions may be implemented in web based instructions, including HTML, XML, etc.

Generally, the interface module 502 may receive user inputs and display user outputs. For example, the interface module 502 may receive one or more attributes. The interface module 502 may further receive a predetermined time period, limiting criterion, and other user inputs. In a further embodiment, the interface module 504 may display cost and duration analysis results. Such analysis results may include statistics, tables, charts, graphs, recommendations, or the like.

Structurally, the interface module 502 may include one or more of an I/O adapter 310, a communications adapter 314, a user interface adapter 316, and/or a display adapter 322. The interface module 502 may further include I/O ports, pins, pads, wires, buses, and the like for facilitating communications between the processor 302 and the various adapters and interface components 310-324. The interface module may also include software defined components for interfacing with other software modules on the CPU 302.

In one embodiment, the CPU 302 may load and execute software modules configured to obtain one or more attributes associated with a subject having a condition, search a database stored on a data storage device for a group of records associated with the attributes, wherein the records comprise cost and duration information associated with the condition, estimate cost and duration in response to the cost and duration information, and generate an output in response to the cost estimate and duration estimate. These software modules may include a search module 504, an estimate module 506, and a generate module 508.

In a specific embodiment, the CPU 302 may load and execute computer software configured to generate, retrieve, send, or otherwise operate SQL instructions. For example, the search module 504 may communicate an SQL query to the data storage device 104 which is configured to search the database for a group of records associated with the attribute, wherein the attribute is associated with a subject having a condition, such as a disease or a disability. In addition, the records may contain cost and duration information associated with the condition. Such a group of records may be associated with individuals identical or similar to the subject in terms of the attributes used by the search module 504, but may be different in some other aspects.

In a certain embodiment, the records may be obtained from a database comprising insurance claim information history of enrollment in a healthcare claim, demographic data, insurance claims data, lab data, pharmacy data, race/ethnicity data, psychographic data, disability, absenteeism, worker compensation data for a large number of customers of a health insurance company or the like. In a particular embodiment, such a database may include historical data spanning ten or more years for several million customers. In such an embodiment, the breadth and depth of the database may provide detailed information regarding a large number of diseases, disabilities, conditions, and their associated stages, services including treatments, procedures, lab test, prescriptions, and outcomes.

In order to search the database, an example of the attribute may include a field value associated with the condition of the subject, such as a healthcare billing or medical code stored in a database of healthcare insurance information, in combination with a field value associated with the subject, for example, a field value that indicates certain specified characteristics of the subject, such as age, gender, minority status, a geographic feature, lab tests, lab results, comorbidity diagnosis, other diseases or diagnoses, use of medication, a genetic feature (presence or absence of a genetic marker such as single nucleotide polymorphism, a specific genotype, a specific gene or gene cluster, a characteristic of a specific chromosome), and the like, or a combination thereof.

In a specific embodiment, the analysis of cost and duration may provide benchmarks based on attributes including co-morbidity conditions shared among a group of individuals, which have not been currently accomplished to the inventors' knowledge.

In one embodiment, such a field value may be a medical code. Non-limiting examples of a medical code may include Episode Treatment Groups® (ETG®), International Classification of Diseases (ICD-9), Current Procedural Terminology (CPT), Ambulatory Surgical Center (ASC), Ambulatory Payment Classifications (APC), Current Dental Terminology (CDT), Code on Dental Procedures and Nomenclature (CDPN), Diagnosis Related Grouping (DRG), Health Care Financing Administration Common Procedure Coding System (HCPCS), National Drug Codes (NDC), Revenue Codes, and Per Diems.

In a certain embodiment, the ETG grouper technology could be used in combination with certain aspects of the invention to create the profile associated with the subject of interest and the subject's condition, for example, an injury profile of the subject. For example, the subject's claim may be processed through an ETG software or algorithm, and a specific ETG could be determined for this subject, which could be used for subsequence search for matched profiles or cohorts. In another aspect, the profile may be created by Natural History of Disease (NHD) technology and tool, by itself or in combination with the ETG or identification of any other attributes.

In one embodiment related to the search operation, the data in the database or datasets may be manipulated using Statistical Analysis Software (SAS) or the like, for example, be categorized. In an exemplary embodiment, the age range for categorization may be divided into: <18, 19-34, 35-49, 50-65, and 65+. For another example, the region of residence for data categorization may be determined by the census: pacific, middle west, northeast, and south, which can be sub-divided into states. For ETGs having low patient count, grouping of several ETGs may be needed for categorization of data.

In a further embodiment, the cost and duration analysis may be updated at a predetermined interval. The update may include updates of new age range and/or region mappings, ETG definitions, etc. The subsequent search and analysis could be updated accordingly.

In a specific embodiment, the search operation may identify a group of individuals having records that include a specified ICD-9 diagnosis code and a demographic feature corresponding to the subject's profile. For example, the search may identify a group of records in the database associated with individuals that have a profile including a specific diagnosis and certain age ranges, gender, residence, and/or comorbidity that may be associated with (e.g., identical or closely related to) the profile of the subject.

In a certain embodiment, the estimate module 506 may be configure to estimate cost and duration of the group of records in response to the cost and duration information contained in the records. For example, the search module may retrieve a group of records associated with a profile matching the profile of the subject having a condition, such as a disability or a disease. The estimate module 506 may then extract the cost and duration information from the identified records. In one embodiment, the cost and duration information may include cost and duration of one or more services associated with the condition. Examples of such services may include treatment, procedures, hospital admissions, rehabilitation, emergency room visit, prescriptions, and the like.

For example, the estimate module 506 may include analogue or digital logic, firmware, or software configured o carry out one or more calculations for estimation according to one or more predefined logic functions. In a further embodiment, the CPU 302 may include a software defined estimate module 506 configured to perform analysis and generation of statistic outputs in response to cost and duration estimates.

In a specific embodiment, the search module 504 may feed retrieved data into a spreadsheet configured to perform one or more estimations by the estimate module 506 on the data. For example, an Excel® spreadsheet may include one or more embedded functions or operations configured to estimate by calculating statistics such as averages, odds ratios, other probabilities, counts, summations, and the like. The data may be automatically imported into a spreadsheet using a macro, a software-based script, or the like. In an alternative embodiment, the estimate module 506 may include hard-coded or dynamically variable software functions for calculating such statistics and generating cost and duration estimates for a user.

In a further embodiment, the estimate module 506 may summarize the cost and duration information by calculating a statistic in response to the cost and duration information extracted. For example, the statistic may include mean, median and standard deviation of cost and duration associated with the condition, such as cost and duration of a treatment for the condition.

In specific embodiments, the cost may be a cost associated with a predetermined time period, or a distribution of cost along the duration period for the treatment. The estimate module 506 may provide estimation of cost in a subset of areas based on episode-related indicators, such as hospital admissions, rehabilitation visit, prescription, emergency room visit, and the like. The cost estimate may further be divided by the service categories such as inpatient, outpatient, physician, or pharmacy. One advantage of this aspect is certain subsets of information may have large fluctuations than the whole records and categorization of cost estimate may minimize the influence of such fluctuations. The estimate module may also provide cost estimate along a continuous time dimension by duration of the associated service, such as treatment of week 1, week 2, week 3 . . . .

In certain embodiment, the duration estimate generated by the estimate module 506 may include utilization statistics of specific places of service, types of service, provider types, or therapeutic classes along the duration of a specific condition or its associated service, such as a long term treatment. In a further embodiment, the estimate module 506 may estimate the duration of a condition, for example, by summarizing frequency distribution of records or individuals with similar profiles or attributes along a continuous time period related to the condition such as a time after the onset of a long term disability or permanent disability, which may include counting records or individuals within each time range of the time period.

In one embodiment, the generate module 508 may generate an output in response to the cost estimate and duration estimate. For example, the generate module 508 may calculate a benchmark for cost and duration of the condition or its associated service, such as costs and duration of treatments from initial diagnosis through all associated time points of the condition. The generate module 508 may provide a statistically-valid benchmark specific for a condition, for example, a benchmark of a future treatment cost for 90% of all injuries of this type.

Alternatively, the generate module 508 may determine ranges and trends for cost and duration of the condition or its associated service: for example, ranges and trends of costs of one or more treatments by stages of condition progression, types of services and providers; and ranges and trends of duration and frequency of treatments in outpatient procedure codes, lab codes, prescriptions, inpatient hospitalizations, or the like. These ranges and trends are based on a group of individuals sharing a similar set of attributes or a similar profile, such as a combination of geographic region, gender, age range, expected future lifetime, or medical code, etc.

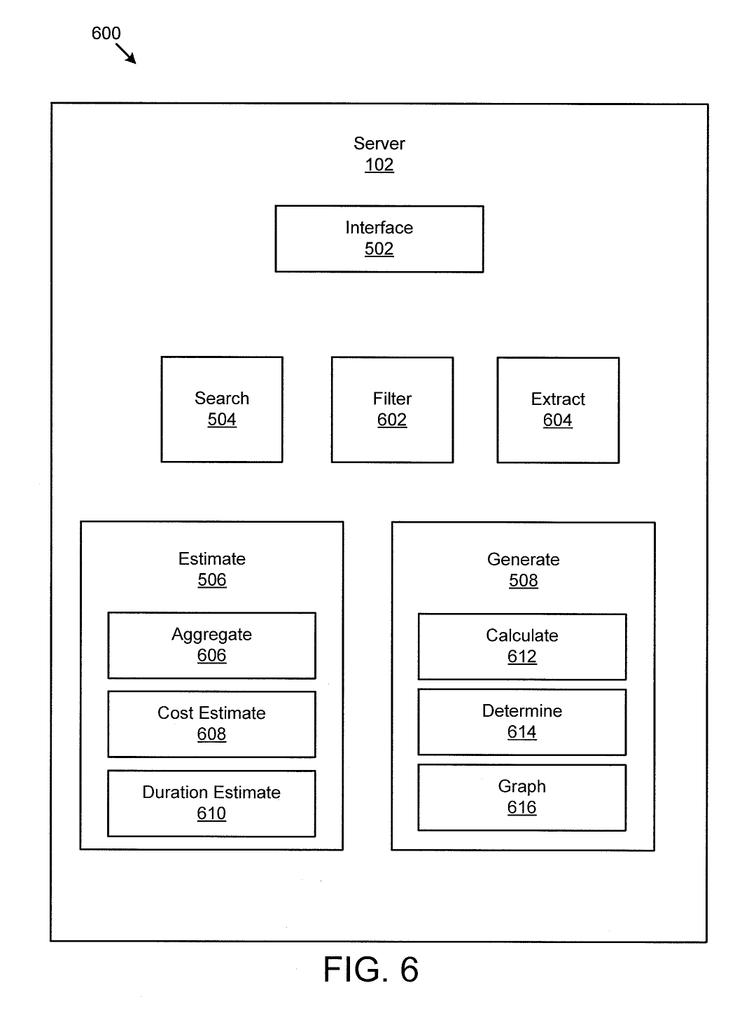

FIG. 6 illustrates a further embodiment of a system 600 for analysis of condition, cost, and duration. The system 600 may include a server 102 as described in FIG. 5. In a further embodiment, the server 102 may include additional software defined modules. For example, the server 102 may include a filter module 602 and an extract module 604. The estimate module 506 may further include an aggregate module 606, a cost estimate module 608, and a duration estimate module 610. The generate module 508 may further include a calculate module 612, a determine module 612, and a graph module 614.

In a further embodiment, the filter module 602 may filter the group of records according to a limiting criterion. The filter module 602 may filter the records for one that are more relevant to the condition, or separate the records according to selected categories. For example, the filter module 602 may filter the group of records by restricting search parameters before the search is performed. Alternatively, the filter module 602 may filter, remove, or otherwise delete the search results according to the criterion. In a certain embodiment, multiple limiting criteria may be used to restrict the scope of the returned search results. In one embodiment, a limiting criteria may include a field value, such as a record date, age, gender, a demographic factor, a geographic factor, a genotype, a phenotype, a condition, a comorbidity diagnosis, a temporal attribute, or the like.

In one embodiment, the extract module 604 may extract the cost and duration information from the group of records. For example, the extracted cost and duration information may have a time span of at least or about one year, two years, three years, five years, ten years, 15 years, 20 years, or any range derivable therein, or any time period associated with the specific condition, such as a period corresponding to an expected life expectancy following initial diagnosis, or a minimal time period needed for recovery of an injury. In certain embodiments, the extract module 604 may extract cost information according to time increments along the duration of a condition or treatment. In one embodiment, the extract module 604 may sort through the records, search cost and duration information, and transfer cost and duration information into a new data storage device.

In a further embodiment, the server 102 may include an aggregate module 606 configured to aggregate records from the group (e.g., a cohort group) according to a selected attribute. For example, the selected attribute may be a temporal index date. The temporal index date maybe a start date of certain event or occurrence associated with the condition, therefore being shared among the group of records. For example, the temporal index date may be the start date of initial diagnosis, treatment, drug administration, procedure, lab tests, or the like. In a certain embodiment, the groups of records may not share the same event but may have a closely related event in each record, such as a similar treatment or administration of a different drug with similar functions. The start date or a characteristic date of such a closely related event may also be used as the index date. By determining and using an index data for the group of records, the aggregate module 606 may normalize or align the records along a time period. The index data could be seconds, hours, years, or combination thereof, depending on circumstances, such as types of events. In one embodiment, the aggregate module 602 may also determine sub-ranges for aggregation of records, such as a series of time ranges of a treatment, e.g., treatment records are aggregated for 0-3 weeks after the index date, 4-6 weeks after the index date, etc.

The server 102 may also include cost estimate module 608 and duration estimate module 610. The estimate modules may estimate cost and duration separately or in combination. For example, the cost estimate module 608 may estimate total cost of a specific treatment associated with a condition of the subject. In another embodiment, the duration estimate module 610 may estimate duration of a condition after initial diagnosis. In certain embodiments, the cost estimate module 608 and the duration estimate module 610 may estimate an integration of cost and duration, such as a plurality of cost estimates along the estimated duration of a condition.

In one embodiment, the server may also include a calculate module 612 configured to calculate one or more benchmarks for specific services, costs and durations. The benchmarks may be calculated in response to the cost and duration estimates provided by the estimate module 506. The calculate module 612 may calculate benchmarks based on conventional statistical analysis of cost and duration estimate and aggregated records, such as regression analysis, simulation, or the like. After the initial benchmarks are set, the calculate module 612 may have the ability to fine-tune the benchmarks by limiting specific characteristics of the records and generate more restricted benchmarks to reduce fluctuations.

In another embodiment, the server may include a determine module 614 configured to determine trends and ranges of cost and duration, such as future treatment costs and patterns for various workers' compensation injuries, specific for a predetermined profile of a combination of a geographic region, gender, age range, expected future lifetime, and/or a medical code, etc. The determine module 614 may also generate a probability of the determined future treatment pattern or cost in response to the cost and duration estimate derived from the records.

In a further embodiment, the server may also include a graph module 616. The graph module 616 may generate, format, or provide a graphical representation of the outputs, such as the benchmarks, the trends and ranges, the statistics, or a graphic user interface for interactive and real time analysis.

These modules 602-616 may be stand-alone modules implemented in hardware, firmware, or software. Alternatively, the functions may be accomplished through commercial calculation products or spreadsheets, software or SQL instructions that are integrated with the other functions of the server 102. In a specific embodiment, the estimate module 506, including some or all of its component modules 606-610, or the generate module 508, including some or all of its component modules 612-616, may communicate the statistics, estimates, and outputs with the interface module 502 for display or communication to a user. The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 7 illustrates one embodiment of a method 700 for analysis of condition, cost, duration. In one embodiment, the method 700 starts when the interface module 502 obtains 702 one or more attributes associated with a subject having a condition. In an embodiment, the interface module 502 may be associated with a profile module to generate a condition profile of the subject (e.g., a natural history of disease profile), which can be used as attributes for search 704. The search module 504 may then search 704 a database for a group of records. The group of records may be associated with the attributes such as a profile or a combination of attributes including a condition identifier and one or more demographic features. In addition, the group of records may contain cost and duration information associated with the condition. For example, the CPU 302 may send an SQL query to the database to retrieve healthcare records associated with similar attributes of the subject, for example, a cohort group of records. The sever 103 may then retrieve the records from the database search 704.

The method 700 may continue when the estimate module 506 estimates 706 cost and duration in response to the cost and duration information comprised in the group of records. In a further embodiment, the generate module 508 may generate 708 one or more outputs in response to the cost estimate and duration estimate of a condition and its associated service(s). For example, a spreadsheet program may generate an output such as cost distribution associated with a condition progression map comprising one or more progression states, which may be specific for the certain attributes used in search 704. Additional outputs may include ranges and trends for treatment patterns and costs, as well as statistics including averages, probabilities, and other computational products.

FIG. 8 illustrates another embodiment of a method 800 for analysis of condition, cost, and duration. In one embodiment, the method 800 starts when the interface module 502 receives 802 one or more attributes, predetermined temporal criteria, and limiting criteria, etc. For example the interface 502 may include a graphical user interface. The interface module 502 may receive user inputs comprising identifiers or indicants of the attributes. Such indicants may include a selection of one or more field values, such as a medical code value, more specifically, an ICD-9 code value, an age value or range, a gender value, an ethnicity status, an income level, a geographical value.

Limiting criterion may include windowing values configured to limit or restrict the time frames from which records could be searched, restrictions on minimal enrollment time, minimum number of records, gender restriction, age restrictions, ethnicity restriction, and other similar threshold and limiting values. The filter module 602 may incorporate the limiting criterion into a query used to search 804 the database for the group of records associated with the attributes. For example, the query may search for all records associated with individuals that have been diagnosed with neck injury, but the query may be restricted to return only results associated with individuals that have at least two years of records after injury in the database.

Alternatively, after search 804 the filter module 602 may filter 806 the records for having cost and duration information matching a predetermined temporal criteria, such as cost and duration information with a time span sufficient to analyze a specified condition. The method 800 may continue when the extract module 604 extracts 808 the cost and duration information meeting the predetermined temporal criteria.

In one embodiment, the aggregation module 606 may aggregate 810 records from the search 804 directly or from the extraction 808. The aggregation 810 may be based on a selected attribute, such as a continuous temporal period divided into several condition progression states, wherein cost and duration information can be aggregated for each condition progression state, such as cancer stages. In another embodiment, the aggregation 810 may aggregate 810 records based on types of services, places of services, types of providers or the like. The estimate module 506 may then estimate 812 cost and duration in response to the aggregated information.

The method 800 may end when the generate module 508 generates useful outputs and graphs for the cost and duration specific for the condition(s) as exemplified in steps 814-816. In one embodiment, the calculate module 612 may calculate 814 one or more benchmarks for cost and duration of the specific condition(s) or the associated services(s). The calculation may generate an average, an odds ratio, or other statistics. In a further embodiment, the determine module 614 may determine 816 future trends and costs for the condition(s) and the associated service(s). The graph module 616 may generate graphs for the calculation and determination of cost and duration.

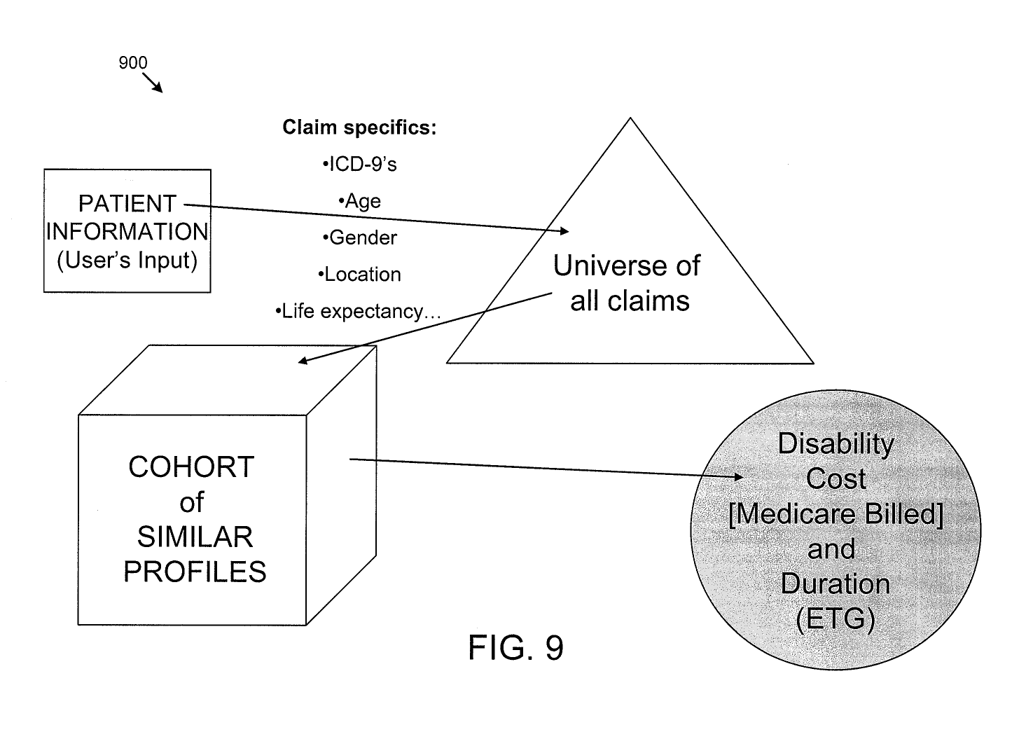

FIG. 9 illustrates one embodiment of a method for analysis of condition, cost, and duration. In this embodiment, a user may use a patient's information as input to find matched cohort's treatment patterns including cost and duration. The patient information may be used to search a universe of all claims (e.g., the NHIDB (national health indicator databases) with over 56 million lives and 14 years of history) and a cohort group of similar profiles (based on similar demographic and geographic factors and case history) may be obtained by real time cohort matching (RTCM). From the identified records of the cohort group, cost information (billed through Medicare) and duration information (ETG grouping) may be extracted and analyzed.

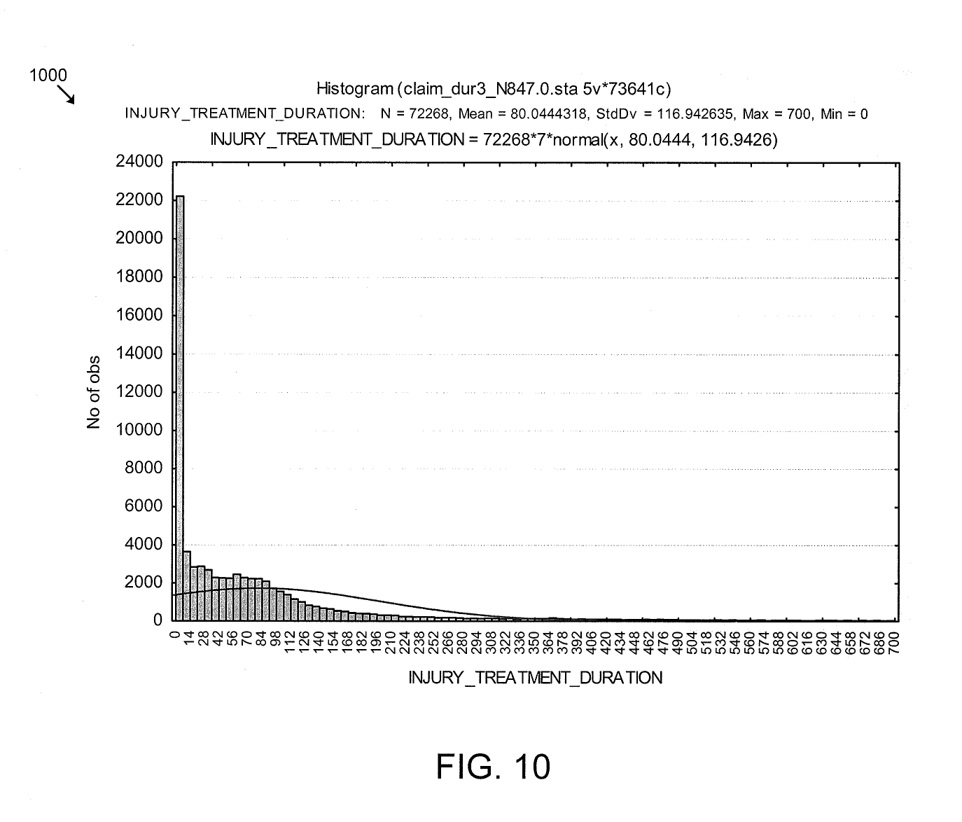

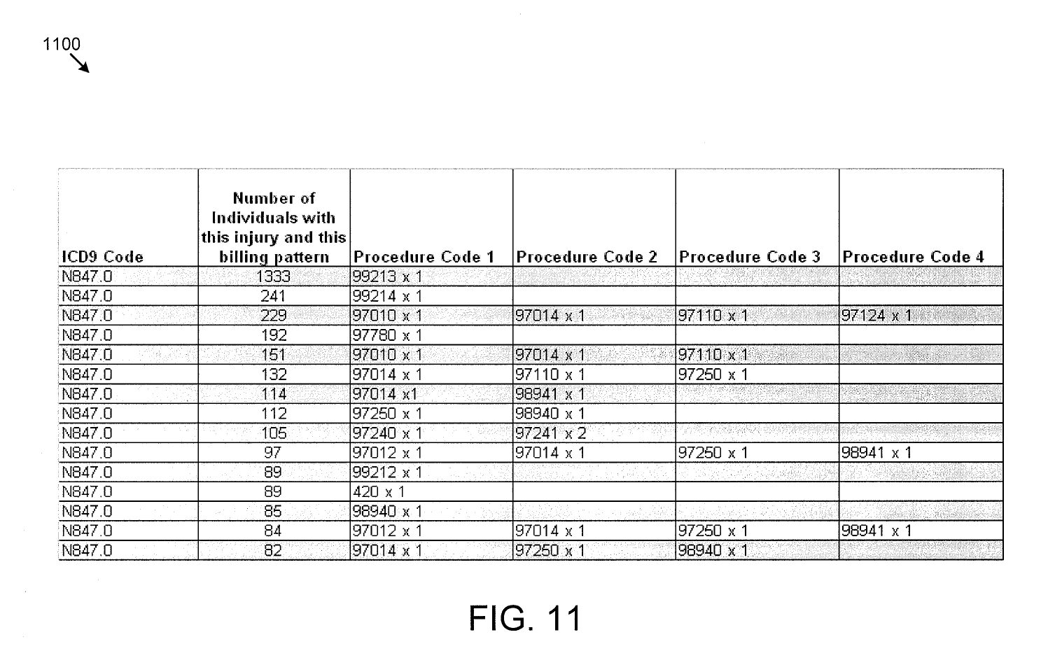

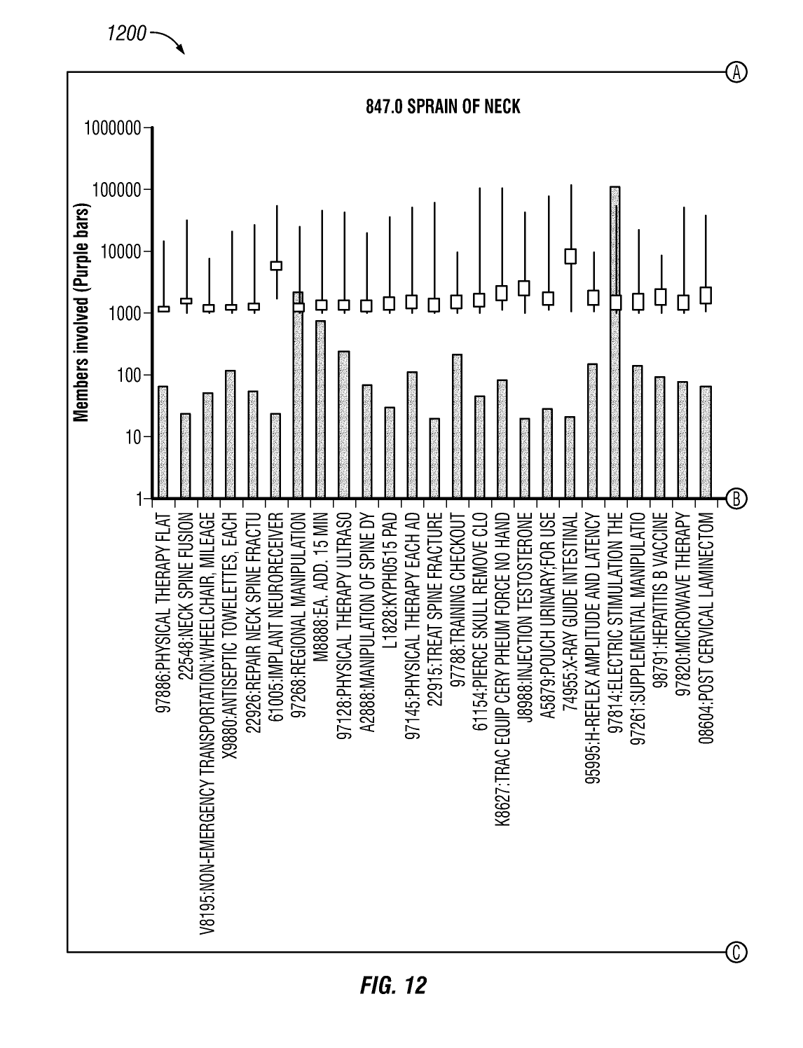

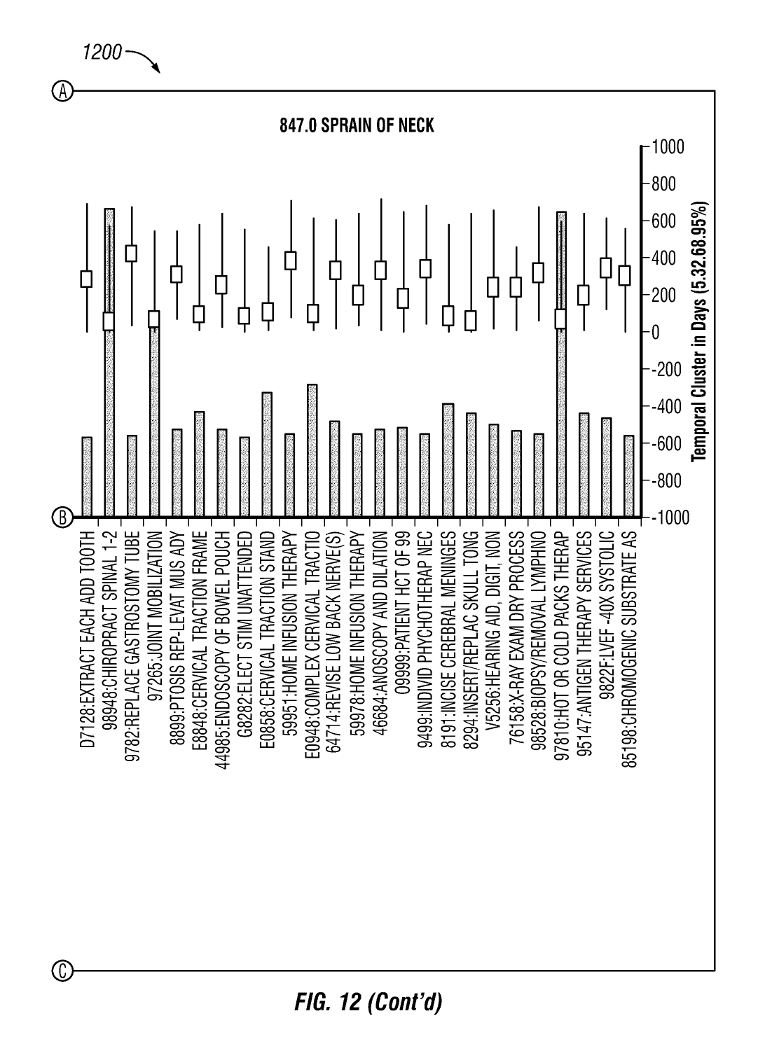

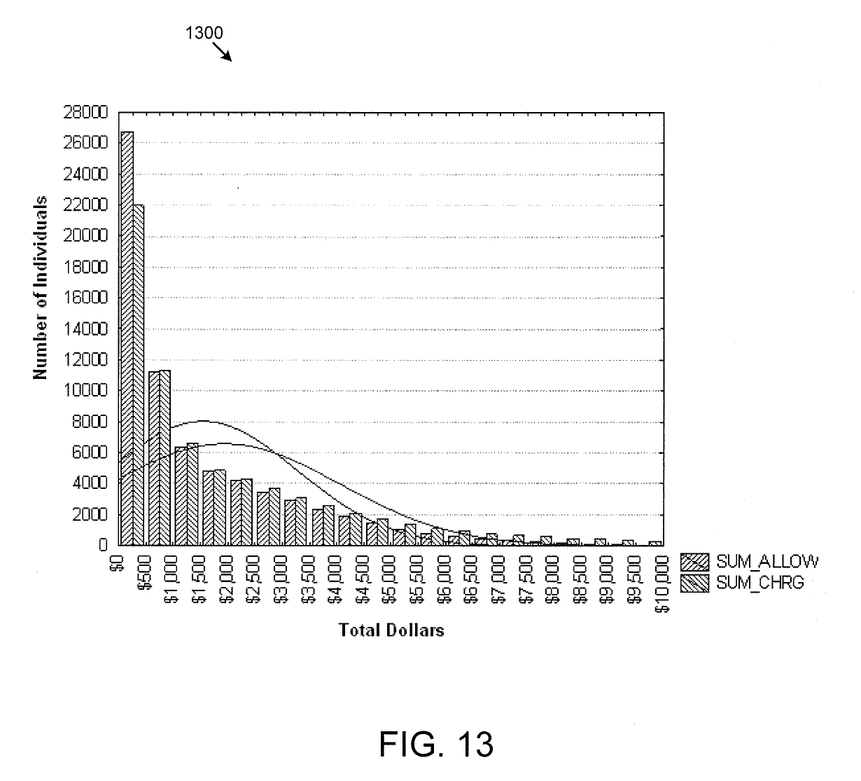

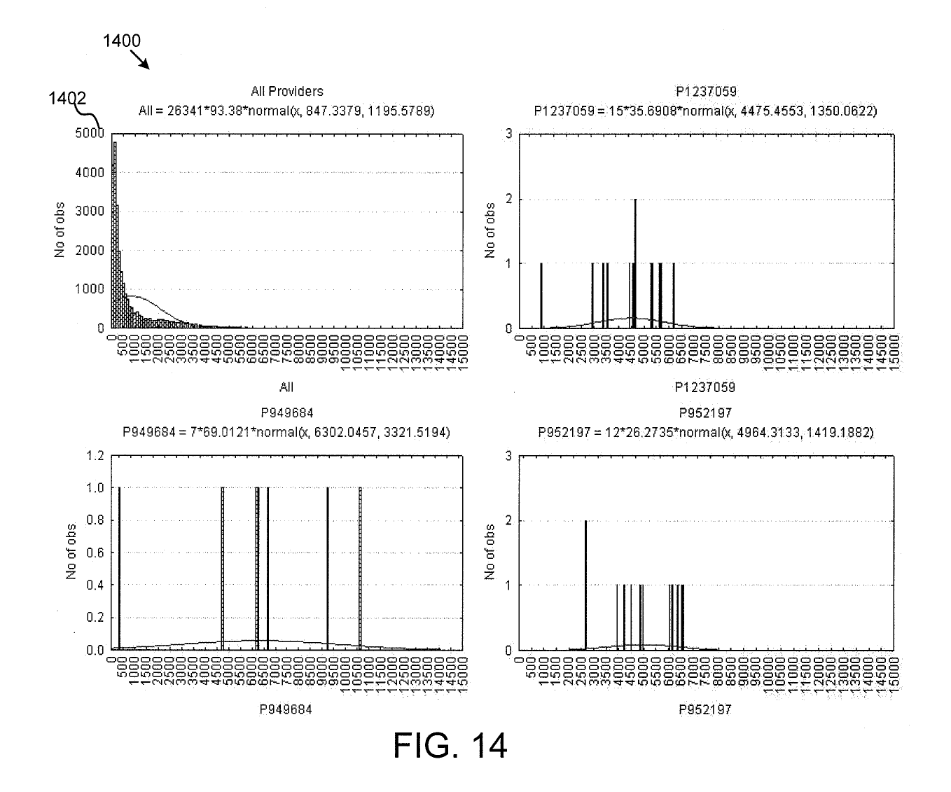

FIGS. 10-14 illustrate various embodiments of graphs or charts that may be generated and analyzed by the estimate module 506 and the generate module 508 related to analysis of a condition such as Neck Sprains with an ICD-9 code of N847.0. For example, the estimate module 506 may count the records along the duration of injury treatment to understand the duration of this injury and generates a histogram graph 1000. FIGS. 11-12 present an analysis of the associated procedures and frequencies by counting the number of individuals with this injury and this billing pattern using different pattern of procedure codes (in Table 1100) and summarizing the frequency and temporal pattern of different procedure and treatment codes (in Graph 1200). Distribution of the overall costs in total dollar amount could be analyzed by counting numbers of individuals in cost ranges as presented in FIG. 13. In a further embodiment, the physician charge patterns may be compared by counting the records in the total dollar amount ranges for all providers, subsets of or individual providers as shown in FIG. 14. This graph 1402 provides a statistically valid benchmark for a physician charge pattern for the specific injury profile by combining data from all providers, in contrast to charge patterns from individual providers with a significant variability in comparison.

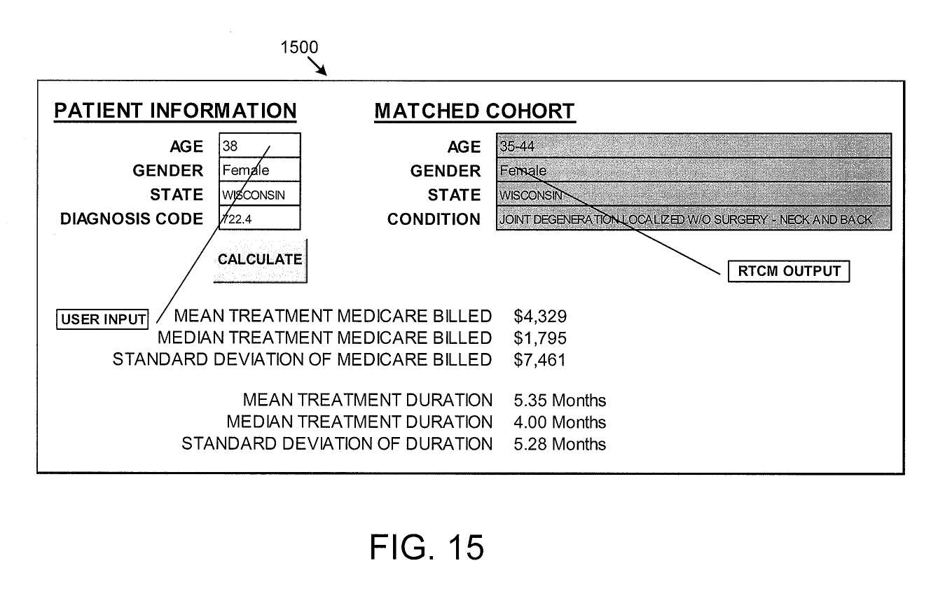

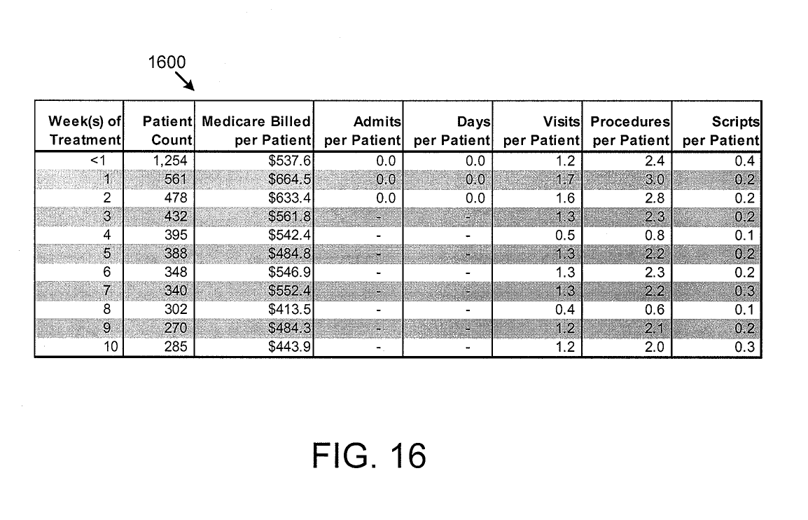

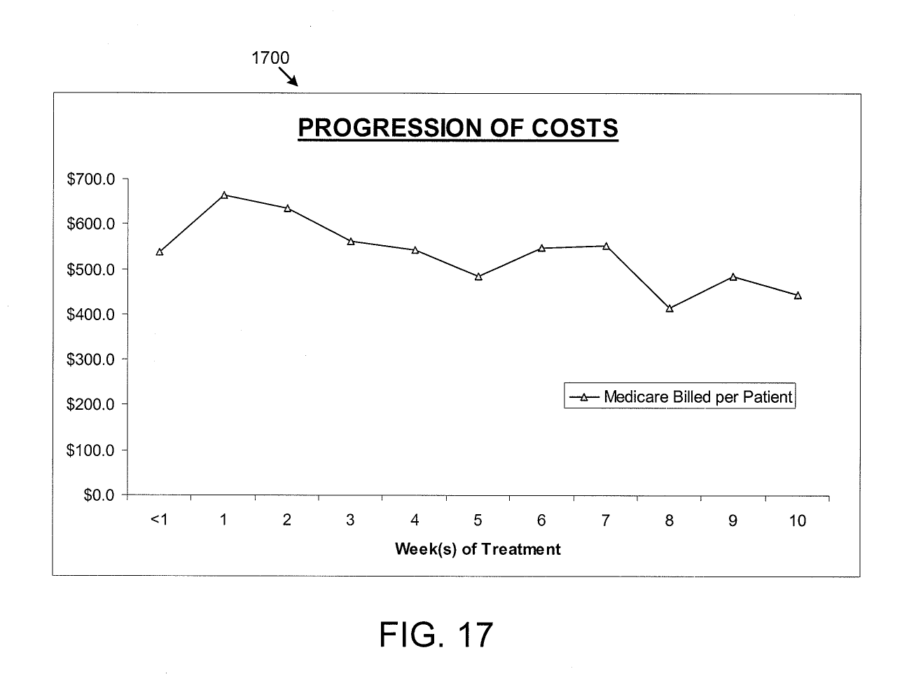

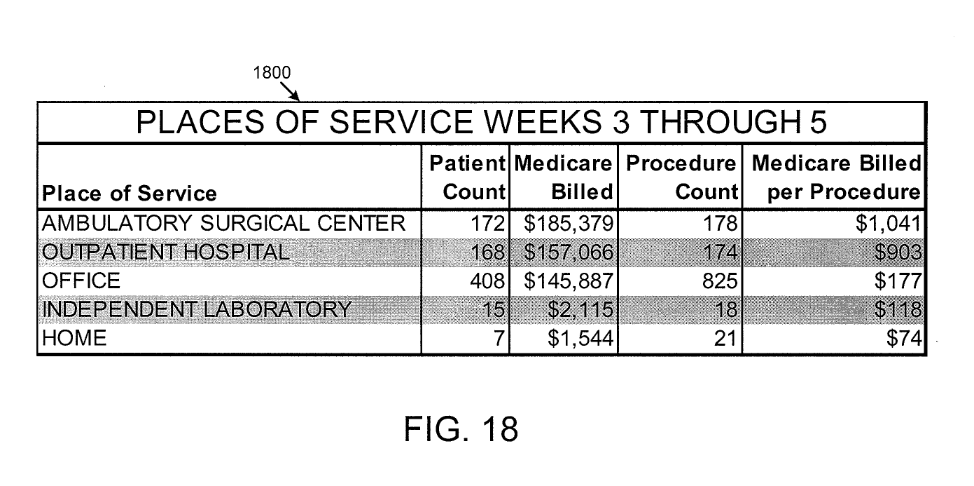

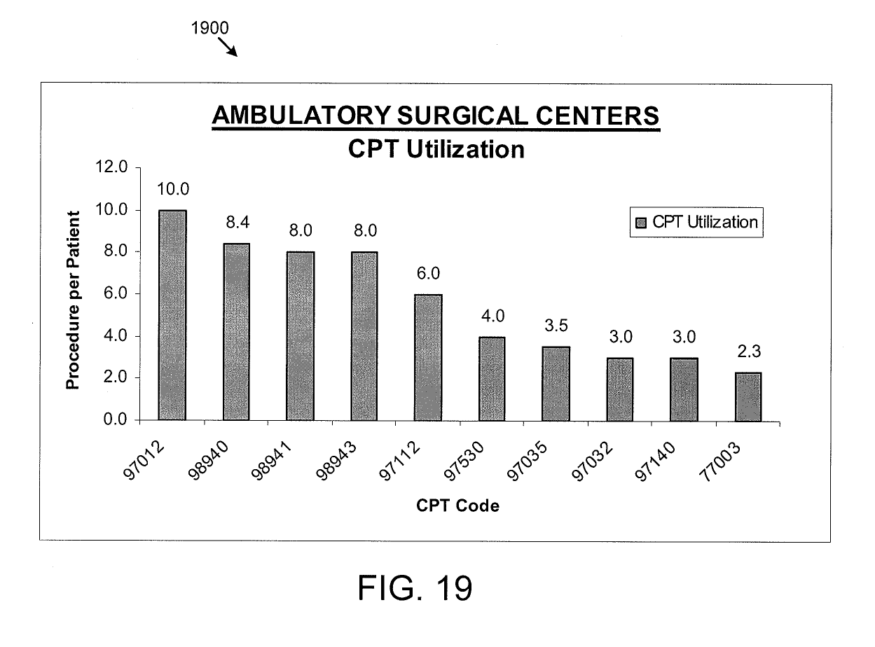

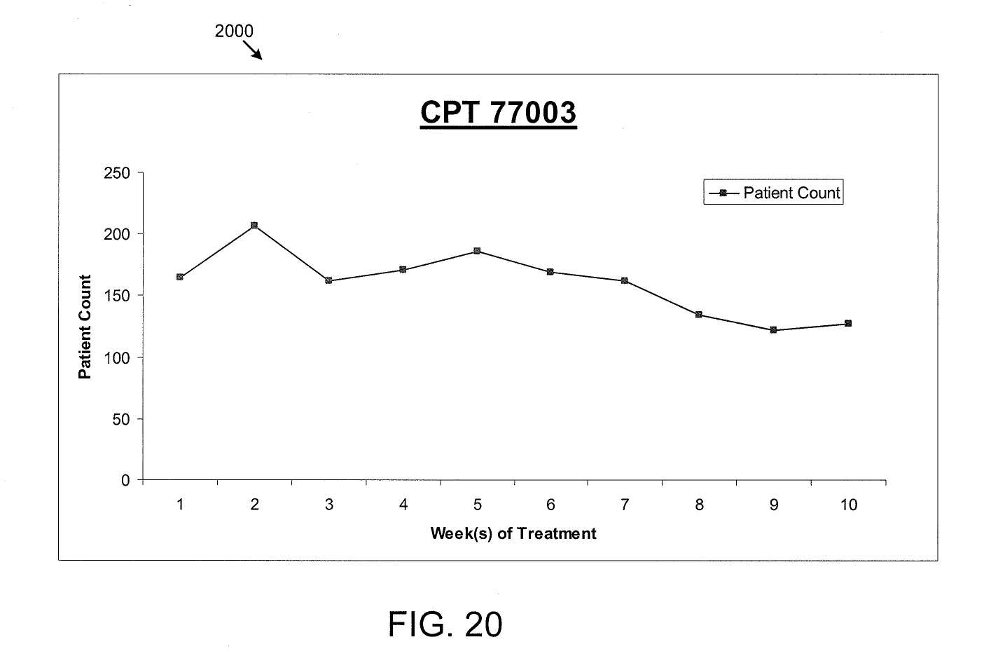

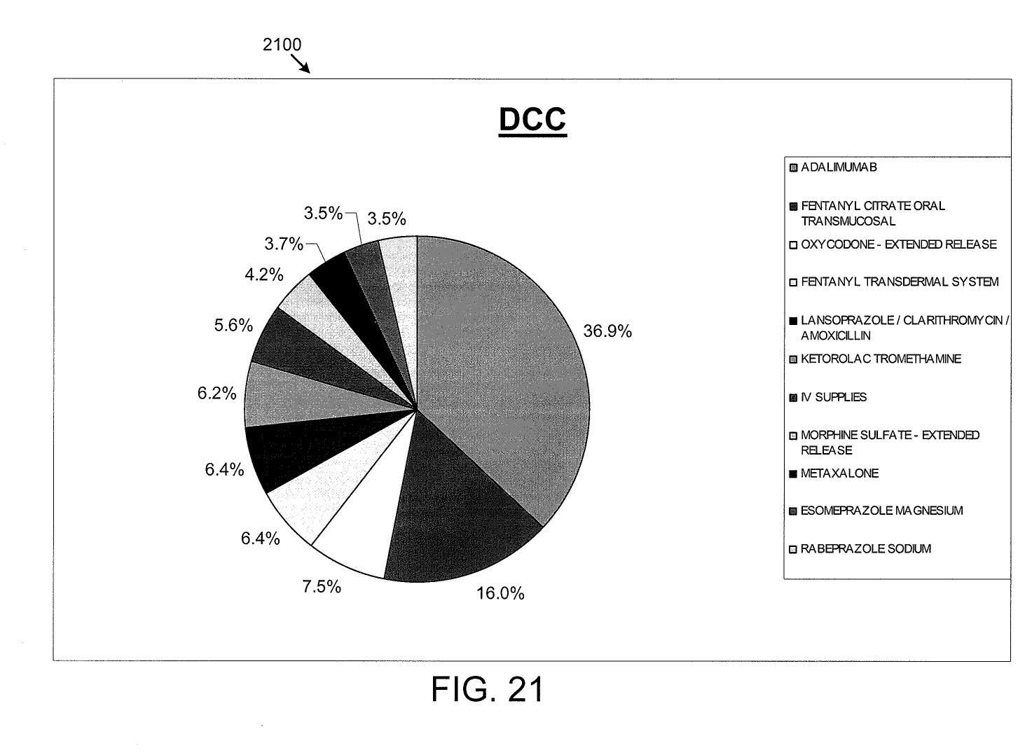

FIGS. 15-21 illustrate various embodiments of graphs or charts that maybe generated and analyzed by the estimate module 506 and the generate module 508 related to analysis of a condition such as degeneration of intervertebral disc with an ICD-9 code of 722.4. For example, FIG. 15 provides an user interface comprising user inputs for entering patient information, matched cohort outputs generated by real-time cohort matching (RTCM), and cost and duration estimates. FIGS. 16-18 illustrate progression of treatment projections by cost and duration analysis along weeks of treatment or a selected time period (e.g., weeks 3 through 5). FIGS. 19-21 illustrate quantifications of cost driver by analyzing frequency and temporal pattern of CPT code utilizations.

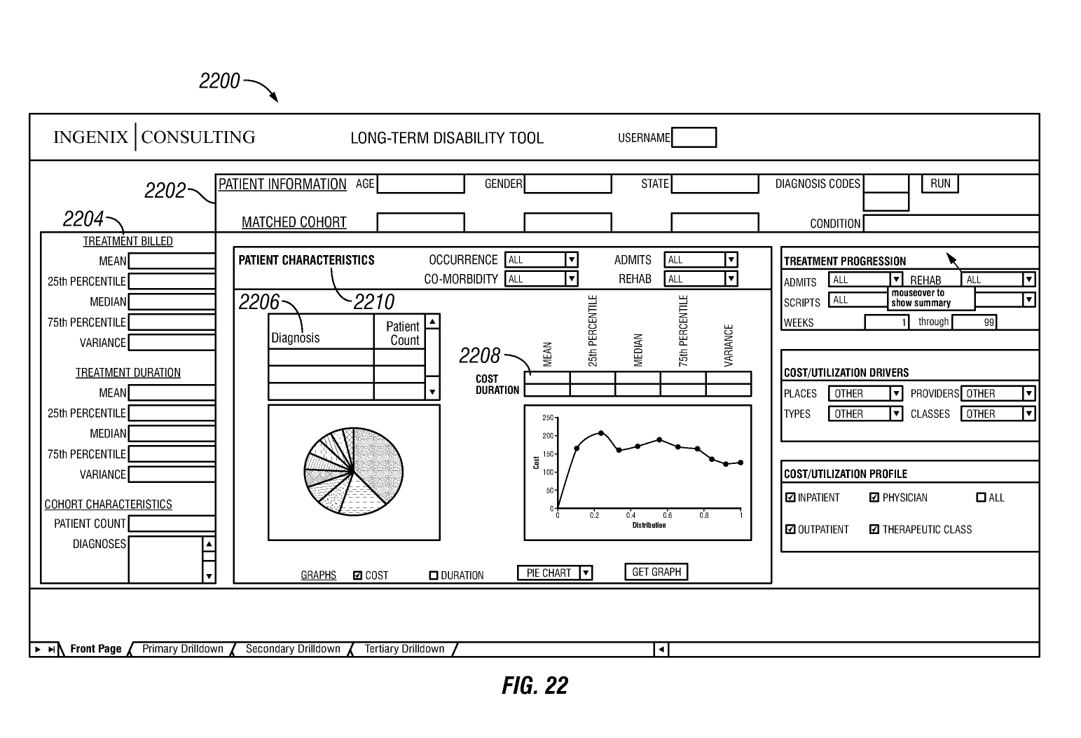

FIG. 22 illustrates one embodiment of a graphical user interface (GUI) 2200 for analysis of condition, cost, and duration. In this embodiment, a GUI for a long term disability (LTD) tool is shown; however, it should be understood that aspects of the LTD tool illustrated in this and following figures could be used for cost and duration for any specific condition or a combination thereof. This embodiment illustrates a front page of an interactive interface that allows for simultaneous view of significant statistics and outputs. As illustrated, the GUI 2200 or a GUI in certain aspects of the present invention may include one or more fields for receiving user inputs, one or more buttons for issuing a command or controlling the server application, or code, and one or more descriptive or informational names or elements for providing user instructions and prompts.

For example, the GUI 2200 contains the user interface which include fields for entering a patient or a claimant's information (“patient information”), which could be used as constraints to find the matched cohorts in accordance with the search module 504. The fields of the patient information may usually include: age, gender, state of residence, and up to two diagnosis codes of a conditions (e.g., a disability) based on ICD-9. In one embodiment, the matched cohorts may consist of patients having the same gender and age range, living in the same region, and diagnosed with a similar disability as determined by the ETG algorithm. These characteristics may be presented under “matched cohorts” corresponding to the fields of “patient information” on the top panel 2202 of the GUI 2200.

In certain embodiments, using the patient information that are entered in the user interface, the matched cohorts' information may be extracted by the extract module 604, and processed in accordance with cost estimate module 608 and duration estimated module 610. The statistics estimates of cost and duration may include mean, median, percentiles (25^{th} percentile and 75 percentile), and standard deviation of cost and duration as presented on the left panel 2204 of the GUI 2200 and illustrated in a line graph 2208. The patient count distribution of diagnoses that make up the matched cohorts may be also calculated and presented in a graph format such as a pie chart 2206. The details driving the mean cost and duration could be summarized and available for print in accordance with the generate module 508 as providing a benchmark for the cost and duration of the treatment of a condition, such as a long term disability. The summary could show the expected total service counts and costs by categories, including the acceptable medical codes.

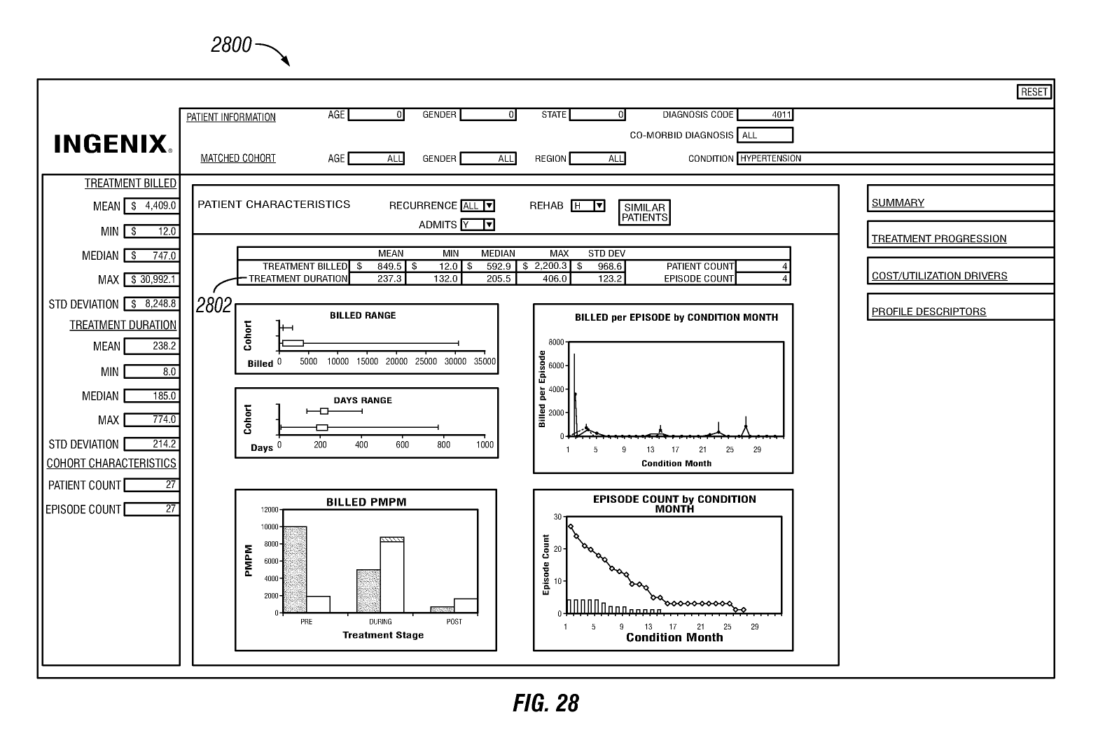

In accordance with the filter module 602, the cost and duration analysis maybe processed and viewed by results from subsets of the standard matched cohorts to reduce potential large fluctuations between records from different subset groups. Subsets may be determined by the indicators of: recurrence of current diagnosis (“occurrence” field); additional co-morbidity in concurrence with current diagnosis (“co-morbidity” field); inpatient admits in previous year (“admit” field); and outpatient rehabilitation visits in previous year (“rehab” field). These indicators may be chosen via drop-downs (containing Y, N, and All as choices) of these fields in the panel 2210 of “Patient Characteristics”). The choice of the drop-down field determines if those patients with recurring episodes could be included in the selection of the matched cohort, which may be further explained in FIG. 28. Graphical interpretations generated by the graph module 616 in this GUI 2200 may include: pie chart of distribution of diagnoses in the matched cohort group, and subsets if “ALL” indicators are chose; line graph of cumulative distribution of cost by patient count; plot graph of patient count lying inside/outside specified confidence interval; line graph of year-to-year trend of cost and duration. In one embodiment, the total matched cohort group can be viewed and processed if all indicators of “Patient Characteristics” are chosen as “All.” In one embodiment, the total matched cohort group could be viewed if all indicators are chose as “All.”

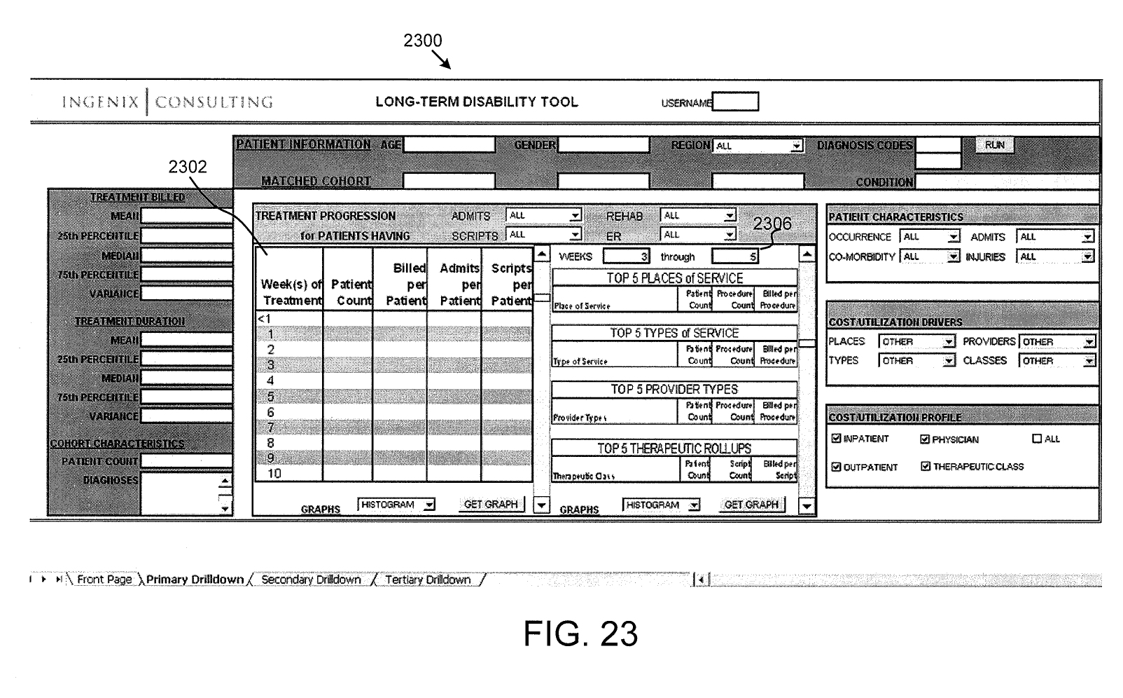

FIG. 23 illustrates one embodiment of a graphical user interface (GUI) 2300 for analysis of condition, cost, and duration. The details driving the calculated benchmarks may be shown on three levels as illustrated in FIGS. 23-25 for primary drilldown, secondary drilldown, and tertiary drilldown of the cost and duration estimate summary, respectively. In one embodiment, the GUI 2300 shows the progression of treatment through a continuous table 2302 of cost and utilization metrics by duration of treatment (e.g., week(s) of treatment). The standard metrics include: count of patients having opened episodes; total costs, admits, days, visits, procedures, and scripts per patient; summary of cost and duration.

Progression of cost and utilization can also be parsed into subsets that may have large fluctuations from the total matched cohort group, for example, by the dropdown list 2304 with episode-related indicators of: hospital admit (‘Admits’), rehabilitation visit (‘Rehab’), prescription (‘Scripts’), and emergency room visit (‘ER’). The first level of drivers of cost and utilization during specific duration increments (e.g., weeks 3 through 5) may be presented as the top 5 places of service, tope 5 types of service, tope 5 provider types, and tope 5 therapeutic classes in panel 2306. The length of increments are dynamic and can be chosen via scroll bar on the top of panel 2306.

Graphical interpretations generated by the graph module 616 in this GUI 2300 may include: line graph of cumulative distribution of cost by duration; high-low graph of cost and utilization at increments of treatment; plot graphs of medical codes (CPT, HCPCS, and/or ICD-9 codes) by duration; pie graphs of distribution of cost in each of the first level drivers, e.g., the top groupings of service categories and/or provider types.

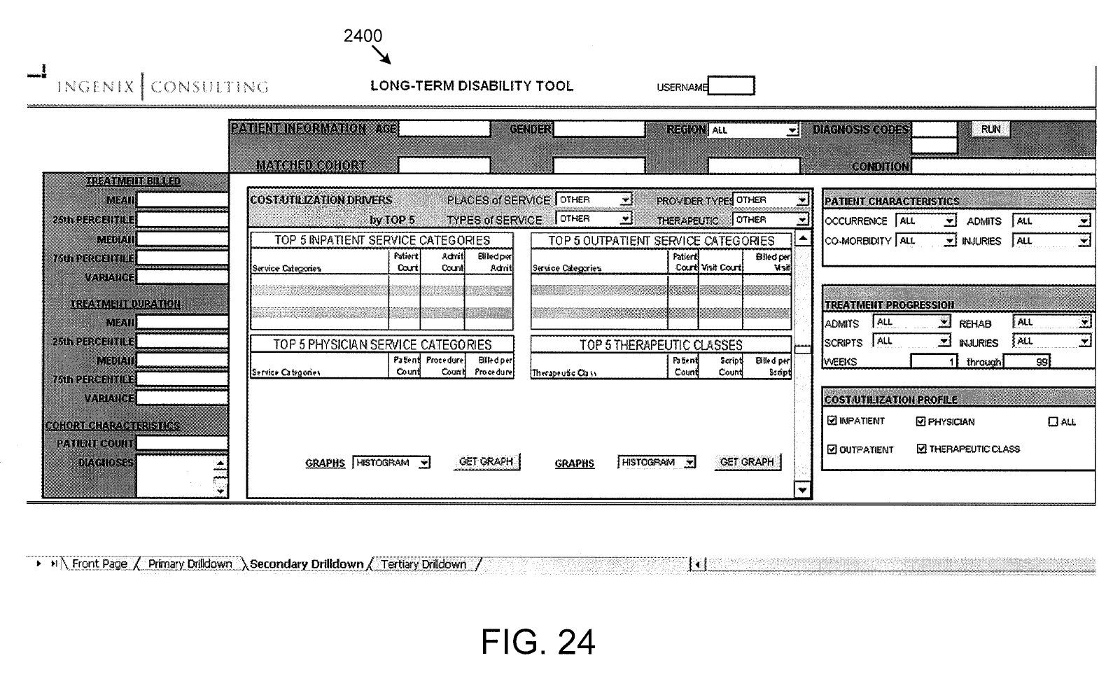

FIG. 24 illustrates one embodiment of a graphical user interface (GUI) 2400 for analysis of condition, cost, and duration. In one embodiment, the GUI 2400 shows the second drilldown of treatment that summarizes cost by service categories, as spliced by the categories in the first level drivers of cost and utilization as described above. The drilldown in the GUI 2400 may show the top service categories of inpatient, outpatient, physician, pharmacy, and the like. Graphical interpretations generated by the graph module 616 in this GUI 2400 may include: pie graph of distribution of cost in each of the drilldown categories; and stacked column chart of medical codes by each of the first level drivers of cost and utilization.

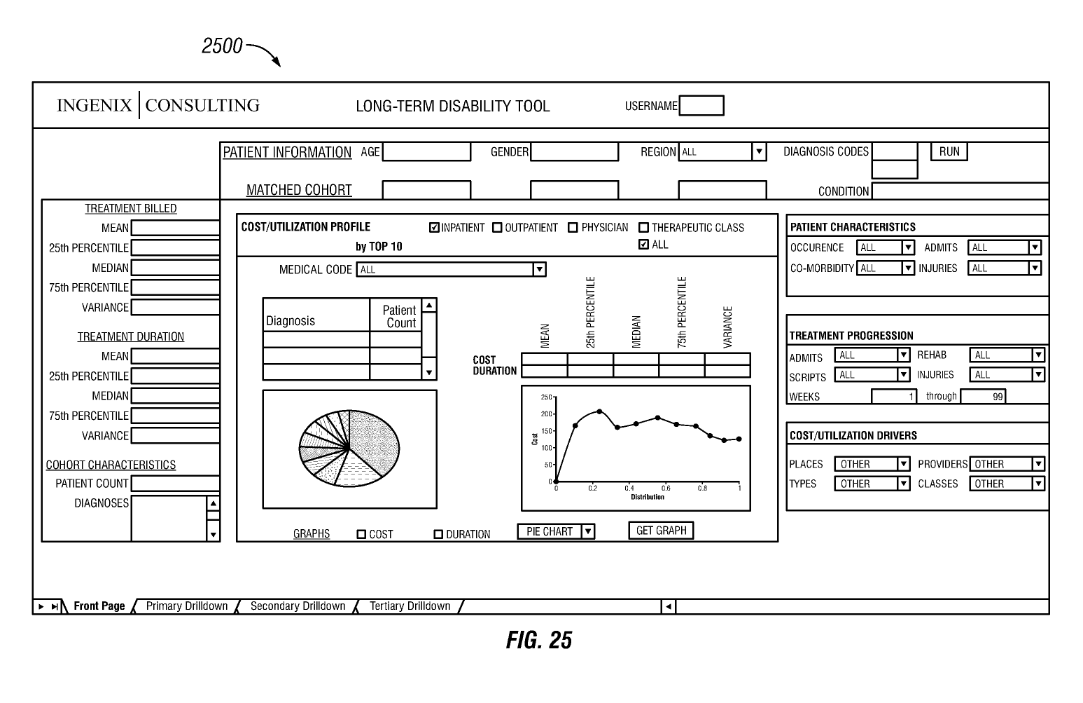

FIG. 25 illustrates one embodiment of a graphical user interface (GUI) 2500 for analysis of condition, cost, and duration. In one embodiment, the GUI 2500 shows the tertiary drilldown that creates a profile of the subsets of the matched cohort group. The subset may have a specific procedure, medical equipment, prescription, or the like, for example, a subset with a cost/utilization profile by top 10 medical codes. The profile may include indicators listed above. The tertiary drilldown may explain the characteristics of patients in the matched cohort group that have certain treatment details.

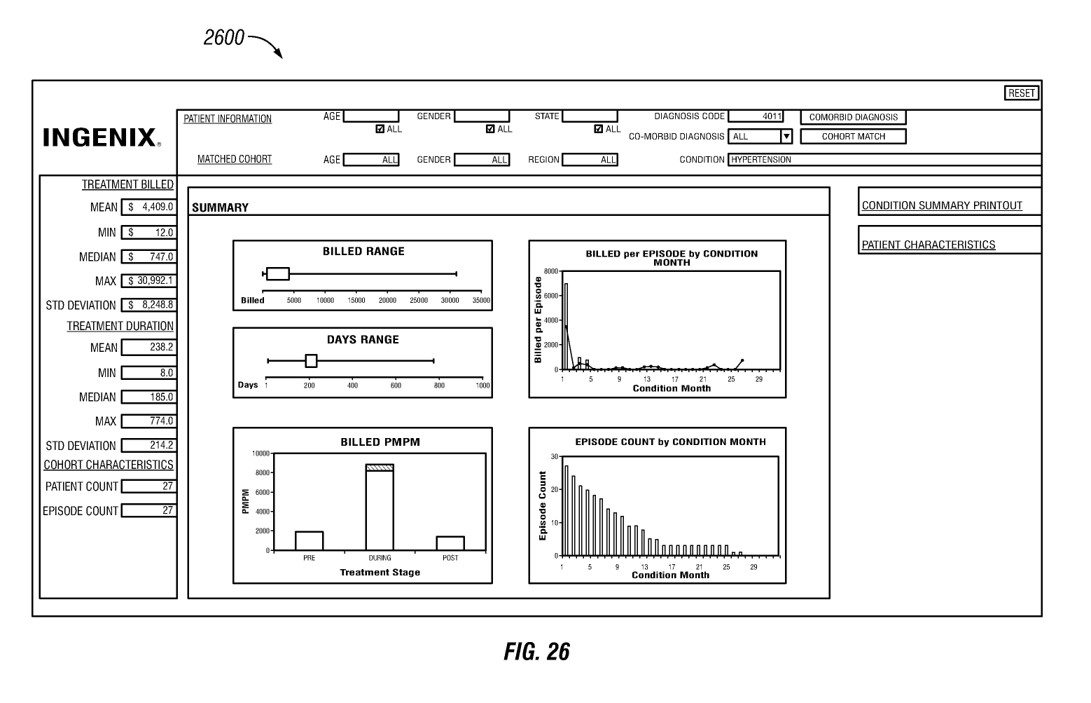

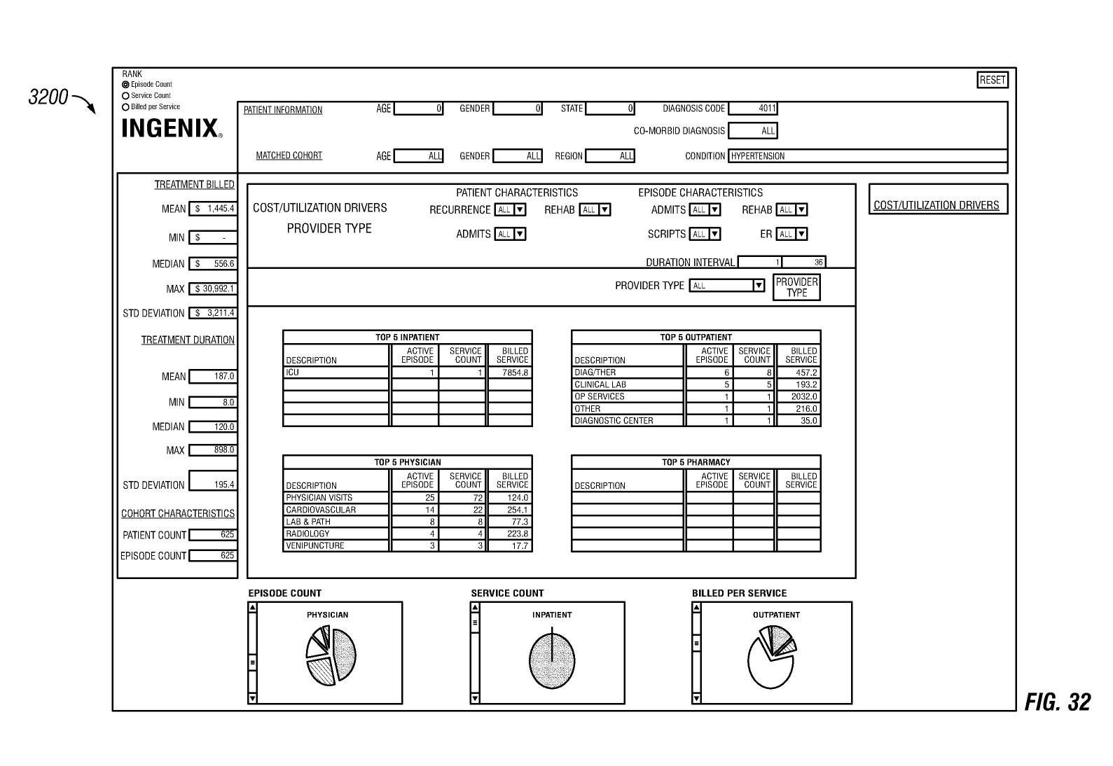

FIGS. 26-32 illustrate the user interface for a cost and duration analytical tool prototype created using Microsoft Excel® as non-limiting examples of the present invention and could be used for analysis of any specific conditions or combinations thereof, such as a long term disability.

FIG. 26 illustrates one embodiment of a graphical user interface (GUI) 2600 for analysis of condition, cost, and duration. In one embodiment, the GUI 2600 shows an example of a cost and duration tab. For example, the cost and duration tab allows the user to enter a patient's initial data, and it then displays the retrieved “Matched Cohort” information. The user may enter the initial data into the top row of entry fields of “Patient Information” and then clicks the “Co-morbid Diagnosis” button. Then the user may select a value in the “Co-Morbid Diagnosis” dropdown list and click the “Cohort Match” button to populate the rest of the fields and charts on the tab. In a certain embodiment, the Matched Cohort may consists of patients having the same gender and age range, living in the same region, and diagnosed with a similar condition as determined by the ETG algorithm as compared with the patient's initial data.

The entry fields for the patient's initial data (“Patient Information” on the GUI 2600) may include the following items (the restrictions listed may not be enforced by the tool, but could help the tool to find a matched cohort group and the selections made could also be reflected on all other tabs with these items):
Age: The patient's age entered by the user must be a positive integer (or zero) for the tool to find an age group range for the Matched Cohort. The age entered may be up to 150 years, or the ‘All’ checkbox may be selected. If the checkbox is checked and an age is also entered, ‘All’ could be used.
Gender: The patient's gender entered by the user could be ‘F’ or ‘M,’ or the ‘All’ checkbox may be selected. If the checkbox is checked and a gender is also entered, ‘All’ could be used.
State: For the tool to correctly find a region for the Matched Cohort, the patient's state of residence entered by the user may be a standard two-character state abbreviation or ‘DC,’ or the ‘All’ checkbox may be selected. If the checkbox is checked and a state is also entered, ‘All’ could be used.
Diagnosis Code: The diagnosis code entered for the patient should be a valid diagnosis code. After the diagnosis code is entered, the “Co-Morbid Diagnosis” button could be clicked to populate the “Co-Morbid Diagnosis” dropdown list.
Co-Morbid Diagnosis: The “Co-Morbid Diagnosis” dropdown list could be populated by clicking the “Co-Morbid Diagnosis” button. The “Diagnosis Code” entry could be used to determine which values the list should include. Any of the values may be selected, including ‘None’ or ‘All.’

For Matched Cohort records that are retrieved in accordance with the search module 504, certain characteristics could be displayed on the GUI 2600, including:
Age: The age range to which the patient's age belongs could be displayed. The age ranges could be <18, 19-34, 35-49, 50-65, and 65+.
Gender: The gender displayed could match the patient's gender entered by the user, or ALL could be displayed if the ‘All’ checkbox is selected.
Region: The region to which the patient's state belongs could be displayed.
Condition: An ETG lookup could be performed on the diagnosis code entered for the patient. The ETG description could be displayed in the “Condition” field.

In accordance with FIGS. 22-25 and the estimate module 506, cost and duration estimate results may be displayed in the GUI 2600 as “Treatment Billed” and “Treatment Duration,” as well as a summary of “Cohort Characteristics.” For example, “Treatment Billed” may include:
Mean: The Matched Cohort Treatment Billed Mean dollar amount.
Min: The Matched Cohort Treatment Billed Minimum dollar amount.
Median: The Matched Cohort Treatment Billed Median dollar amount.
Max: The Matched Cohort Treatment Billed Maximum dollar amount.
Std Deviation: The Matched Cohort Treatment Billed Standard Deviation dollar amount.

In one embodiment, “Treatment Duration” may include:
Mean: The Matched Cohort Treatment Duration Mean days.
Min: The Matched Cohort Treatment Duration Minimum days.
Median: The Matched Cohort Treatment Duration Median days.
Max: The Matched Cohort Treatment Duration Maximum days.
Std Deviation: The Matched Cohort Treatment Duration Standard Deviation days.

In a further embodiment, “Cohort Characteristics” may include:
Patient Count: The Matched Cohort Patient Count.
Episode Count: The Matched Cohort Episode Count.

In certain embodiments, the GUI 2600 may further display output in accordance with the generate module 508, such as calculated benchmarks and ranges and trends of cost and duration. For example, the GUI 2600 shows Summary graphs such as a “Billed Range Graph,” a “Days Range Graph,” a “Billed PMPM graph” (Billed per member per month graph), and a “Billed per Episode by Condition Month Graph.”

In one embodiment, buttons may be used to execute a certain function or the like. In the GUI 2600, the Reset button may clear all of the entry fields on all tabs when clicked. the Co-morbid Diagnosis button could populate the Co-Morbid Diagnosis dropdown list based on the Diagnosis Code entered. The Cohort Match button could populate the Matched Cohort, Treatment Billed/Duration, and Cohort Characteristics fields, as well as the Summary graphs, based on the information in the entry fields.

In another embodiment, the GUI 2600 may contain the Condition Summary Printout link that could take the user to the Condition Summary tab in the GUI 2700 when clicked. The Patient Characteristics link could take the user to the Patient Characteristics tab in the GUI 2800.

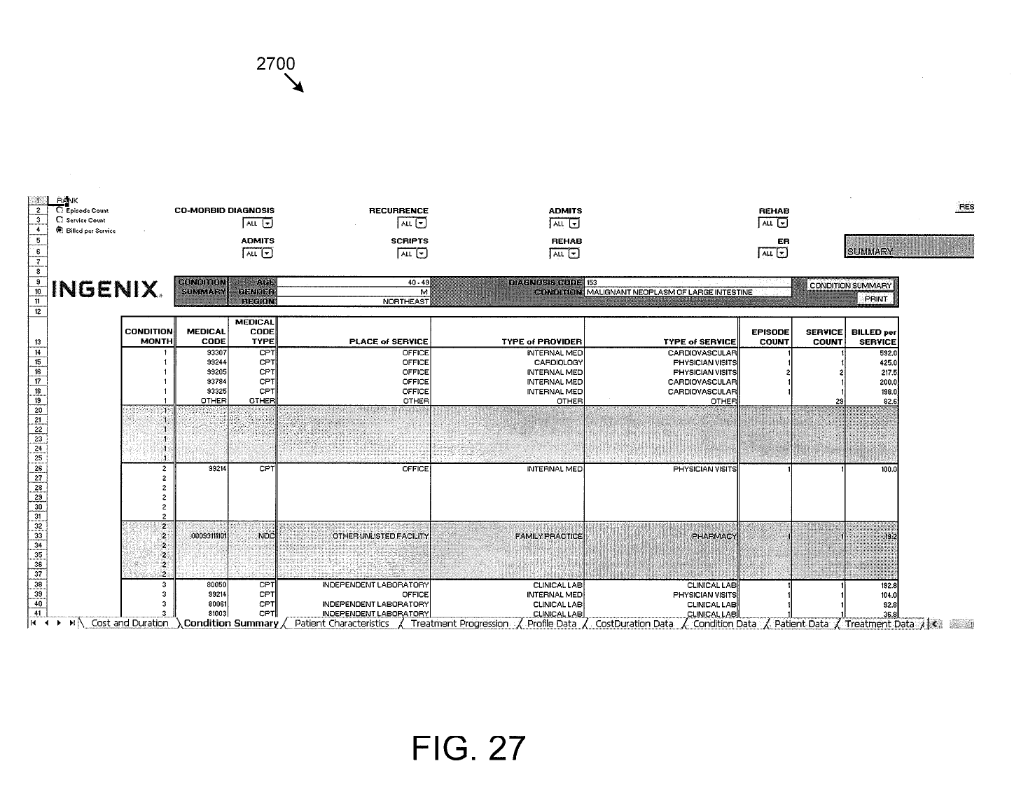

FIG. 27 illustrates one embodiment of a graphical user interface (GUI) 2700 for analysis of condition, cost, and duration. In one embodiment, the GUI 2700 shows an example of a Condition Summary tab. The Condition Summary tab allows the user to narrow the characteristics included in the Matched Cohort determination. The matched cohort information from the Cost and Duration tab in the GUI 2600 could be copied to the corresponding fields on this tab. The user may select the desired choices from the radio buttons and dropdown lists before clicking the “Condition” button to populate the detailed grid.

The selection fields for the Condition Summary tab include the following items: rank, patient characteristics, episode characteristics, condition summary, detailed grid, buttons, and links.

The Rank radio buttons of the GUI 2700 may include Episode Count, Service Count, and Billed per Service as choices. The selection determines the descending sort order, within Condition Month and data type (medical or drug), of the items in the grid. When the Rank is changed on this tab, it could also be changed on the other tabs containing the Rank radio buttons.

The Patient Characteristics are in the top line of dropdown lists of the GUI 2700, including the following items:
Co-Morbid Diagnosis: The Co-Morbid Diagnosis dropdown list contains the Co-Morbid Diagnosis codes from the Cost and Duration tab in the GUI 2600, including ‘None’ and ‘All’ as choices. The selection determines whether those patients with a Co-Morbid Diagnosis could be included in the refined selection of the Matched Cohort. If one of the codes is selected, patients with a Co-Morbid Diagnosis could be included. If ‘None’ is selected, patients with a Co-Morbid Diagnosis could not be included. If ‘All’ is selected, patients could be included whether or not they have a Co-Morbid Diagnosis.
Recurrence: The Recurrence dropdown list contains Y, N, and All as choices. The selection determines whether those patients with recurring episodes could be included in the refined selection of the Matched Cohort.
Admits: The Admits dropdown list contains Y, N, and All as choices. The selection determines whether those patients with inpatient claims could be included in the refined selection of the Matched Cohort.
Rehab: The Rehab dropdown list contains Y, N, and All as choices. The selection determines whether those patients with rehabilitation claims could be included in the refined selection of the Matched Cohort.

The Episode Characteristics are in the second line of dropdown lists of the GUI 2700, including:
Admits: The Admits dropdown list contains Y, N, and All as choices. The selection determines whether those episodes with inpatient claims could be included in the refined selection of the Matched Cohort.
Scripts: The Scripts dropdown list contains Y, N, and All as choices. The selection determines whether those episodes with prescription claims could be included in the refined selection of the Matched Cohort.
Rehab: The Rehab dropdown list contains Y, N, and All as choices. The selection determines whether those episodes with rehabilitation claims could be included in the refined selection of the Matched Cohort.
ER: The ER dropdown list contains Y, N, and All as choices. The selection determines whether those episodes with emergency room claims could be included in the refined selection of the Matched Cohort.
Condition Summary: The information in the Condition Summary grid is carried over from the Cost and Duration tab. It may not be modified on this tab.

The detailed grid in the GUI 2700 is populated based on the entries on the Cost and Duration tab and the selections made on this tab. The top 5 in rank for each condition month and data type (medical or drug) is listed in the grid, followed by an “Other” line for anything not in the top 5 in rank. The rows with a white background contain medical data and the rows with a gray background contain drug data.

For the GUI 2700, some buttons and links may also be included. The Reset button could clear all of the entry fields on all tabs when clicked. The Condition button could populate the detailed grid on the tab based on the selections made. The Print button could send the Condition Summary and detailed grid to the user's default printer. The Summary link could take the user to the Cost and Duration tab in the GUI 2600 when clicked.

FIG. 28 illustrates one embodiment of a graphical user interface (GUI) 2800 for analysis of condition, cost, and duration. In one embodiment, the GUI 2800 shows an example of a Patient Characteristics tab. The Patient Characteristics tab allows the user to enter patient characteristics to narrow the Matched Cohort determination. The Patient Information entered on the Cost and Duration tab in the GUI 2600 is copied to the corresponding fields on this tab, but they may not be modified on this tab. The Matched Cohort, Treatment Billed, Treatment Duration, and Cohort Characteristics information is also carried over from the Cost and Duration tab in the GUI 2600. After the user makes the desired selections in the dropdown lists, the Similar Patients button should be clicked to populate the grid and charts on this tab. For example, the Treatment grid is populated when the Similar Patients button is clicked, and it shows the statistics with the further restrictions of the selected patient characteristics. Queries and calculations are handled on the Patient Data tab.

The Patient Characteristics of the GUI 2800, including the following fields: Recurrence, Admits, and Rehab as described in the GUI 2700. The Treatment grid 2802 is populated when the Similar Patients button is clicked, and it shows the statistics with the further restrictions of the selected patient characteristics. Queries and calculations are handled on the Patient Data tab.

The GUI 2800 may also include summary graphs such as Billed Range Graph, Days Range Graph, Billed PMPM Graph, Billed per Episode by Condition Month Graph, Episode Count by Condition Month Graph, which include both the base data from the Cost and Duration tab and data showing the further restrictions of the selected patient characteristics.

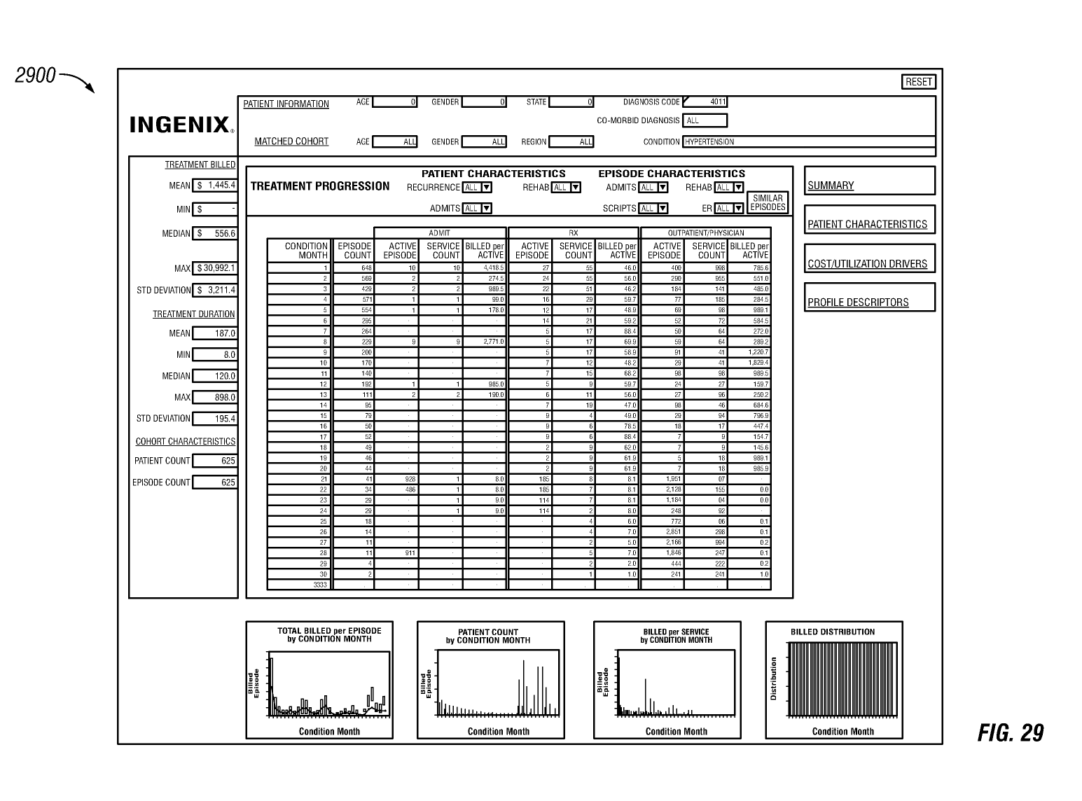

FIG. 29 illustrates one embodiment of a graphical user interface (GUI) 2900 for analysis of condition, cost, and duration. In one embodiment, the GUI 2900 shows an example of a Treatment Progression tab. The Treatment Progression tab allows the user to enter episode characteristics to narrow the Matched Cohort determination. The patient information entered on the Cost and Duration tab and the patient characteristics selected on the Patient Characteristics tab are copied to the corresponding fields on this tab. The user may not modify the patient information on this tab, but the patient characteristics selections may be changed. The Matched Cohort, Treatment Billed, Treatment Duration, and Cohort Characteristics information is also carried over from the Cost and Duration tab. After the user makes the desire selections in the dropdown lists, the Similar Episodes button could be clicked to populate the grid and charts on this tab.

The GUI 2900 include entry filed of Patient Characteristics and Episode Characteristics as described above. More items of the Treatment Progression tab may include:
Treatment Progression Grid: The Treatment Progression grid is populated when the Similar Episodes button is clicked. Statistics are displayed for up to 30 condition months, with the remainder combined in one total at the end of the grid. Queries and calculations are handled on the Treatment Data tab.
Total Billed per Episode by Condition Month Graph: The Billed per Episode by Condition Month graph is linked to the same graph on the Treatment Graph tab, where the graph is populated from information in the Treatment Data tab. It includes both the maximum billed per episode and the average billed per episode.
Patient Count by Condition Month Graph: The Patient Count by Condition Month graph is linked to the same graph on the Treatment Graph tab, where the graph is populated from information in the Treatment Progression grid. It includes the total episode count, the admission count, the prescription count, and the office visits count.
Billed per Service by Condition Month Graph: The Billed per Service by Condition Month graph is linked to the same graph on the Treatment Graph tab, where the graph is populated from information in the Treatment Progression grid. It includes the amount billed for admissions, for medications, and for office visits.
Billed Distribution Graph: The Billed Distribution graph is linked to the same graph on the Treatment Graph tab, where the graph is populated from information in the Treatment Progression grid. It shows the distribution by percentages of the billed amounts for admissions, medications, and office visits, for each condition month.

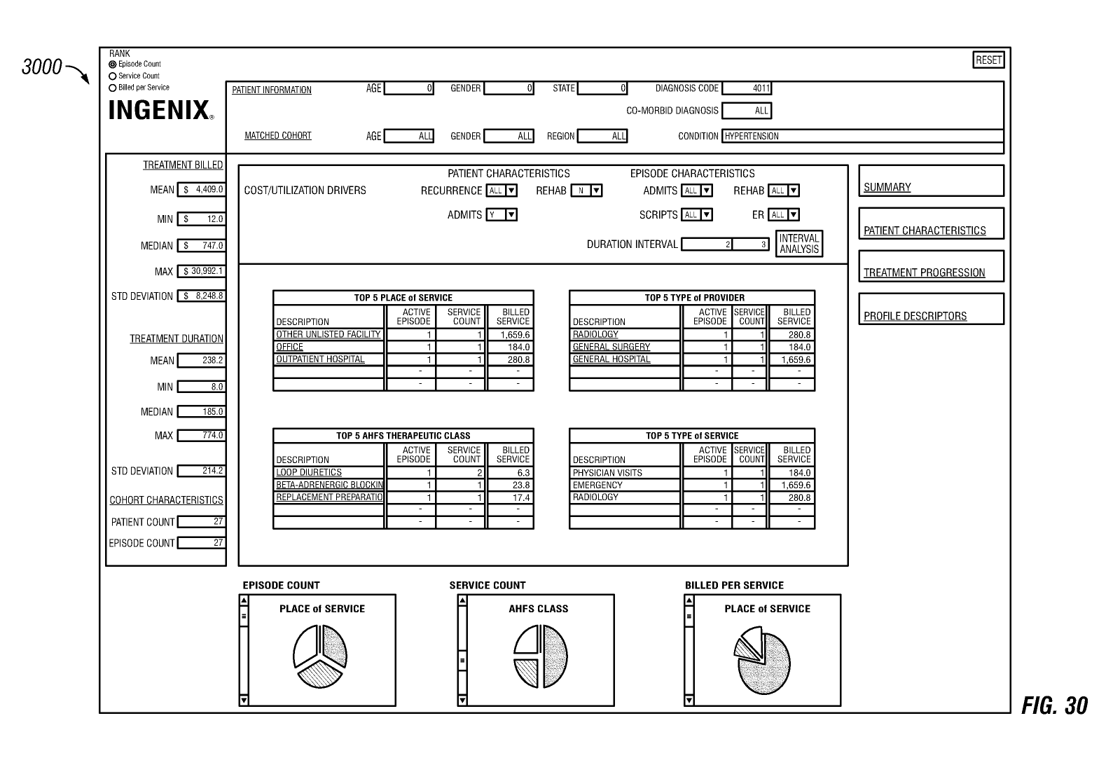

FIG. 30 illustrates one embodiment of a graphical user interface (GUI) 3000 for analysis of condition, cost, and duration. In one embodiment, the GUI 3000 shows an example of a Cost and Utilization Driver tab. The Cost and Utilization Drivers tab allows the user to select cost and utilization drivers to narrow the Matched Cohort determination. The information entered on previous tabs is copied to the corresponding fields on this tab, including the Matched Cohort, Treatment Billed, Treatment Duration, and Cohort Characteristics information from the Cost and Duration tab, and the user may modify the patient and episode characteristics on this tab. After the user enters data into the entry fields, the Interval Analysis button should be clicked to populate the grid and charts on this tab.

The Cost and Utilization Driver tab include several previously described fields such as Rank, Patient Characteristics, and Episode Characteristics, and more fields including:
Duration Interval: The Duration Interval fields contain the beginning and ending values of the desired episode duration in number of months. The values entered should be positive integers. These fields could cause only those episodes lasting the indicated number of months (within the range entered) to be included in the selection of the Matched Cohort.
Cost and Utilization Drivers: The following grids and graphs are populated when the Interval Analysis button is clicked.
Top 5 Place of Service Grid—The Top 5 Place of Service grid lists the top five places of service, in descending order based on the order of the rank selected. The data is taken from the Cost and Utilization Service Place tab, the Service Data tab, and the Drivers Data tab. Clicking on a description in the grid could take the user to the Cost and Utilization Service Place tab.
Top 5 Type of Provider Grid—The Top 5 Type of Provider grid lists the top five types of providers, in descending order based on the order of the rank selected. The data is taken from the Cost and Utilization Service Provider tab and the Drivers Data tab. Clicking on a description in the grid could take the user to the Cost and Utilization Service Provider tab.
Top 5 AHFS Therapeutic Class Grid—The Top 5 AHFS Therapeutic Class grid lists the top five AHFS therapeutic classes, in descending order based on the order of the rank selected. The data is taken from the Cost and Utilization Service AHFS tab and the Drivers Data tab. Clicking on a description in the grid could take the user to the Cost and Utilization Service AHFS tab.
Top 5 Type of Service Grid—The Top 5 Type of Service grid lists the top five types of service, in descending order based on the order of the rank selected. The data is taken from the Drivers Data tab.
Episode Count Graph—The Episode Count graph is linked to the same graph on the Drivers Graph tab, where it is populated from data on the Drivers Data tab. It includes Place of Service, Type of Provider, AHFS Class, and Type of Service pie charts.
Service Count Graph—The Service Count graph is linked to the same graph on the Drivers Graph tab, where it is populated from data on the Drivers Data tab. It includes Place of Service, Type of Provider, AHFS Class, and Type of Service pie charts.
Billed per Service Graph—The Billed per Service graph is linked to the same graph on the Drivers Graph tab, where it is populated from data on the Drivers Data tab. It includes Place of Service, Type of Provider, AHFS Class, and Type of Service pie charts.

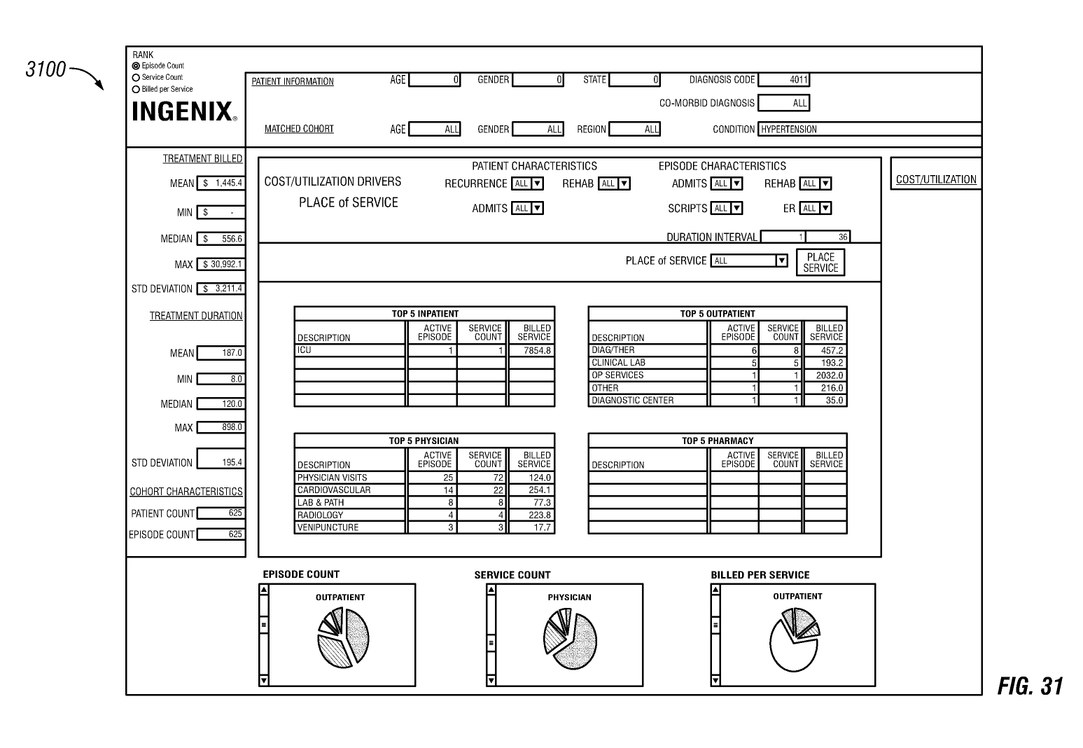

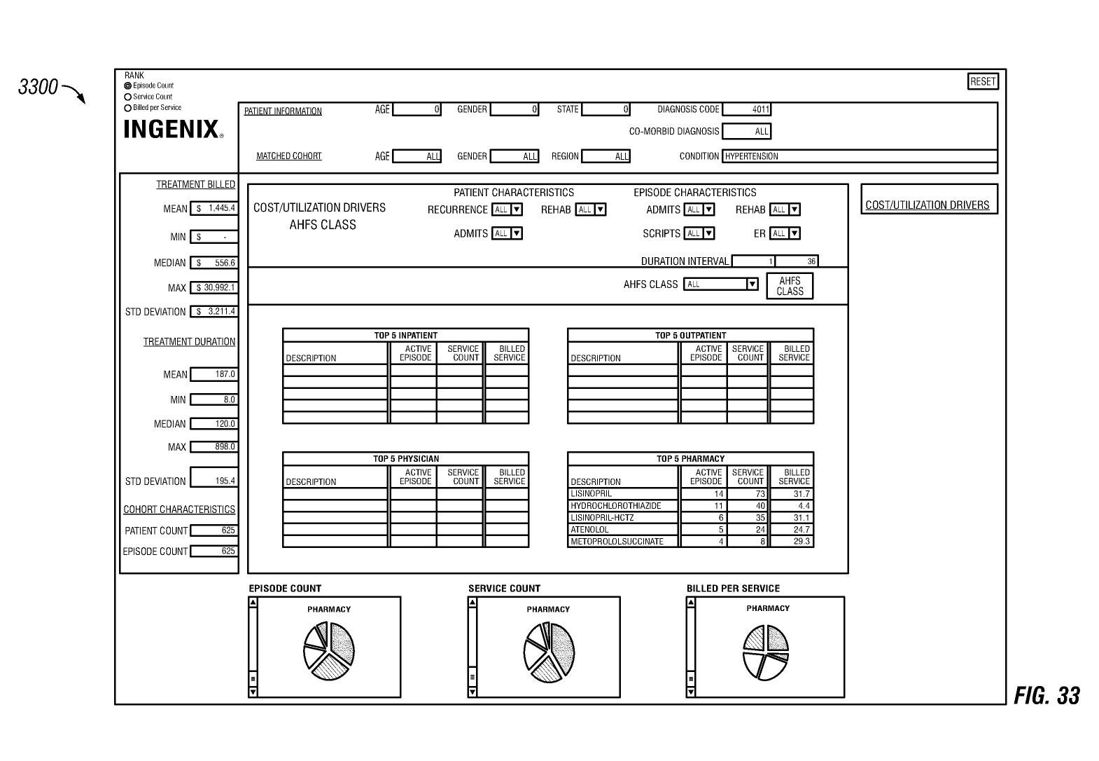

FIGS. 31-33 illustrate one embodiment of a graphical user interface (GUI) for analysis of condition, cost, and duration. In one embodiment, the GUIs show examples of a cost and utilization service place/provider/AHFS™ (the American Hospital Formulary Service®) tab. For example, The Cost and Utilization Service Place tab in FIG. 31 allows the user to select a place of service to narrow the Matched Cohort determination. The information entered on the previous tabs is copied to the corresponding fields on this tab, and the user may modify the patient and episode characteristics on this tab. The Matched Cohort, Treatment Billed, Treatment Duration, and Cohort Characteristics information is also carried over from the Cost and Duration tab. After the user makes the desired selections, the Place Service button should be clicked to populate the grids and charts on this tab.

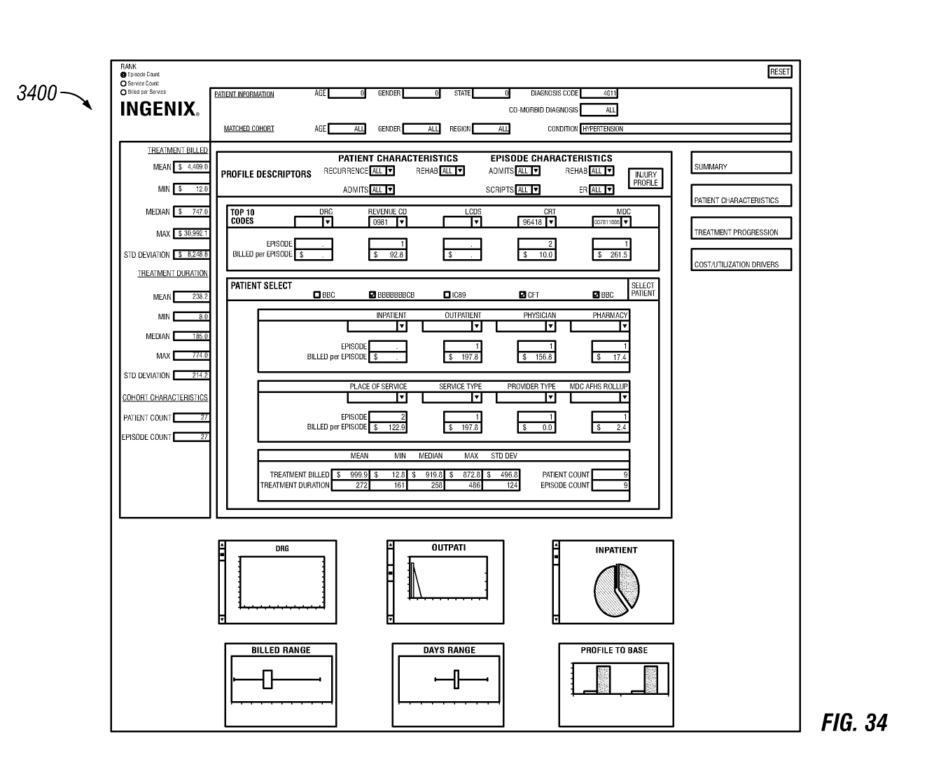

FIG. 34 illustrates one embodiment of a graphical user interface (GUI) 3400 for analysis of condition, cost, and duration. In one embodiment, the GUI 3400 shows an example of a Profile Description tab. The Profile Descriptors tab allows the user to select profile descriptors to narrow the Matched Cohort determination. The information entered on the previous tabs is copied to the corresponding fields on this tab, and the user may modify the patient and episode characteristics on this tab. The Matched Cohort, Treatment Billed, Treatment Duration, and Cohort Characteristics information is also carried over from the Cost and Duration tab. After the user makes the desired selections, the Injury Profile button and the Select Patient button should be clicked to populate the grids and charts on this tab. The entry fields for the Profile Descriptors tab include the following items. The selections made could also be reflected on all other tabs with these items.

The Top 10 Codes section of the GUI 3400 includes the following five categories, with a dropdown list and episode information for each. The lists are populated when the Injury Profile button is clicked, and are each sorted in descending order of the rank selected. The episode count and amount per episode could change as the selection in the dropdown list above it is changed. The DRG dropdown list contains all DRG codes that were included in the claims for the current matched cohort. The episode count and amount per episode are displayed beneath the selected DRG code. The Revenue CD dropdown list contains all Revenue codes that were included in the claims for the current matched cohort. The episode count and amount per episode are displayed beneath the selected Revenue code. The ICD9 dropdown list contains all ICD9 codes that were included in the claims for the current matched cohort. The episode count and amount per episode are displayed beneath the selected ICD9 code. The CPT dropdown list contains all CPT codes that were included in the claims for the current matched cohort. The episode count and amount per episode are displayed beneath the selected CPT code. The NDC dropdown list contains all NDC codes that were included in the claims for the current matched cohort. The episode count and amount per episode are displayed beneath the selected NDC code.

The Patient Selector section of the GUI 3400 includes the following checkboxes. The ‘Patient Must Incur ALL Checked Codes’ checkbox controls whether the selected codes for the selected code types could be added to the query with ‘and’ or ‘or’ between them. If the checkbox is unchecked, the default ‘or’ could be used and a claim could be included for the matched cohort if it contains any of the codes selected; if it is checked, ‘and’ could be used and a claim could be included only if it contains all of the codes selected. This could only apply if more than one code type is selected. For example, if the DRG checkbox is selected, the selected DRG code could be used to filter the matched cohort. If there is no DRG code, it could not affect the query.

The first grid in the Patient Selector section of the GUI 3400 includes the following four categories, with a dropdown list and episode information for each. The lists are populated when the Select Patients button is clicked, and are each sorted in descending order of the rank selected. The episode count and billed per service amount could change as the selection in the dropdown list above it is changed. The Inpatient dropdown list contains the inpatient provider categories from the claims included in the matched cohort. The episode count and amount per episode are displayed beneath the selected inpatient category. The Outpatient dropdown list contains the outpatient provider categories from the claims included in the matched cohort. The episode count and amount per episode are displayed beneath the selected outpatient category. The Physician dropdown list contains the physician provider categories from the claims included in the matched cohort. The episode count and amount per episode are displayed beneath the selected physician category. The Pharmacy dropdown list contains the pharmacy provider categories from the claims included in the matched cohort. The episode count and amount per episode are displayed beneath the selected pharmacy category.

The second grid in the Patient Selector section of the GUI 3400 includes the following four categories, with a dropdown list and episode information for each. The lists are populated when the Select Patients button is clicked, and are each sorted in descending order of the rank selected. The episode count and billed per service amount could change as the selection in the dropdown list above it is changed. The Place of Service dropdown list contains the place of service categories from the claims included in the matched cohort. The episode count and amount per episode are displayed beneath the selected place of service category. The Service Type dropdown list contains the service type categories from the claims included in the matched cohort. The episode count and amount per episode are displayed beneath the selected service type category. The Provider Type dropdown list contains the provider type categories from the claims included in the matched cohort. The episode count and amount per episode are displayed beneath the selected provider type category. The NDC AHFS Rollup dropdown list contains the NDC AHFS rollups from the claims included in the matched cohort. The episode count and amount per episode are displayed beneath the selected NDC AHFS rollup category.

All of the methods disclosed and claimed herein can be made and executed without undue experimentation in light of the present disclosure. While the system and methods of this invention have been described in terms of preferred embodiments, it could be apparent to those of skill in the art that variations may be applied to the methods and in the steps or in the sequence of steps of the method described herein without departing from the concept, spirit and scope of the invention. In addition, modifications may be made to the disclosed system and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A method for cost and duration analysis comprising:
obtaining one or more attributes associated with a subject having a condition;
searching a database stored on a data storage device for a group of records associated with the attributes, wherein the records comprise cost and duration information associated with the condition;
estimating cost and duration in response to the cost and duration information; and
generating an output in response to the cost estimate and duration estimate.

2. The method of claim 1, wherein the condition is a short term disability.

3. The method of claim 1, wherein the condition is a long term disability.

4. The method of claim 1, wherein the condition is a permanent disability.

5. The method of claim 1, further comprising extracting cost and duration information of a predetermined time period.

6. The method of claim 1, further comprising filtering the records according to a limiting criteria.

7. The method of claim 1, further comprising aggregating the records based on the cost and duration information.

8. The method of claim 1, further comprising calculating a benchmark for cost and duration of the condition or its associated service.

9. The method of claim 1, further comprising generating the output comprises determining ranges and trends for cost and duration of the condition or its associated service.

10. A system comprising:
a data storage device configured to store a database comprising one or more records;
a server in data communication with the data storage device, suitably programmed to:
obtain one or more attributes associated with a subject having a condition;
search a database stored on a data storage device for a group of records associated with the attributes, wherein the records comprise cost and duration information associated with the condition;
estimate cost and duration in response to the cost and duration information; and
generate an output in response to the cost estimate and duration estimate.

11. The system of claim 10, wherein the condition is a short term disability.

12. The system of claim 10, wherein the condition is a long term disability.

13. The system of claim 10, wherein the condition is a permanent disability.

14. The system of claim 10, wherein the server is further configured to extract cost and duration information of a predetermined time period.

15. The system of claim 10, wherein the server is further configured to filter the records according to a limiting criteria.

16. The system of claim 10, wherein the server is further configured to aggregate the records based on the cost and duration information.

17. The system of claim 10, wherein the server is further configured to calculate a benchmark for cost and duration of the condition or its associated service.

18. The system of claim 10, wherein the server is further configured to determine ranges and trends for cost and duration of the condition or its associated service.

19. A tangible computer program product comprising a computer readable medium having computer usable program code executable to perform operations comprising:
obtaining one or more attributes associated with a subject having a condition;
searching a database stored on a data storage device for a group of records associated with the attributes, wherein the records comprise cost and duration information associated with the condition;
estimating cost and duration in response to the cost and duration information; and
generating an output in response to the cost estimate and duration estimate.

20. The tangible computer program product of claim 19, wherein the condition is a short term disability.

21. The tangible computer program product of claim 19, wherein the condition is a long term disability.

22. The tangible computer program product of claim 19, wherein the condition is a permanent disability.

23. The tangible computer program product of claim 19, further comprising extracting cost and duration information of a predetermined time period.

24. The tangible computer program product of claim 19, further comprising filtering the records by a limiting criteria.

25. The tangible computer program product of claim 19, further comprising aggregating the records based on the cost and duration information.

26. The tangible computer program product of claim 19, further comprising generating the output comprises calculating a benchmark for cost and duration of the condition or its associated service.

27. The tangible computer program product of claim 19, further comprising generating the output comprises determining ranges and trends for cost and duration of the condition or its associated service.
